(19) United States
(12) Patent Application Publication
(10) Pub. No.: US 2025/0139369 A1
(43) Pub. Date: May 1, 2025

(54) TRAINING MULTI-MODAL FOUNDATION MODEL

(71) Applicant: BEIJING BAIDU NETCOM SCIENCE TECHNOLOGY CO., LTD., BEIJING (CN)

(72) Inventors: Jingbo ZHOU, BEIJING (CN); Congxi XIAO, BEIJING (CN); Yixiong XIAO, BEIJING (CN); Jizhou HUANG, BEIJING (CN)

(21) Appl. No.: 18/956,107

(22) Filed: Nov. 22, 2024

(30) Foreign Application Priority Data
Aug. 23, 2024 (CN) 202411171380.5

(51) Int. Cl. G06F 40/284; G06N 20/00

(52) U.S. Cl. CPC G06F 40/284; G06N 20/00

(57) ABSTRACT

A method is provided that includes: obtaining first urban data of a first sample urban region; inputting the first urban data into a multi-modal foundation model to obtain respective predicted vector representations of a plurality of first data segments; obtaining a plurality of general-purpose foundation models that are pre-trained; for each general-purpose foundation model: generating a vector representation label of a first data segment of a corresponding data modality by using the general-purpose foundation model; and determining a knowledge distillation loss of the general-purpose foundation model based on the vector representation label and a predicted vector representation of the first data segment; and adjusting parameters of the multi-modal foundation model based on at least respective knowledge distillation losses of the plurality of general-purpose foundation models.

### CROSS-REFERENCE TO RELATED APPLICATIONS

This application claims priority to Chinese patent application No. 2024111713805, filed on Aug. 23, 2024, the contents of which are hereby incorporated by reference in their entirety for all purposes.

### TECHNICAL FIELD

The present disclosure relates to the technical field of artificial intelligence, in particular, to the technical fields such as smart cities, natural language processing, computer vision, and foundation models, and specifically to a method for training a multi-modal foundation model, an electronic device, and a computer-readable storage medium.

### BACKGROUND ART

With the continuous acceleration of a global urbanization process, complexity and diversity of a region as a basic unit of a city are increasingly prominent. The region not only carries people's life, work, and entertainment activities, but also reflects a socio-economic status and vitality of the city. Therefore, it is increasingly important to quantitatively represent and understand an urban region, thereby gaining a deeper insight into an inner structure and dynamic changes of a city, and further providing decision-making support for scientific and reasonable urban planning and administering.

Methods described in this section are not necessarily methods that have been previously conceived or employed. It should not be assumed that any of the methods described in this section is considered to be the prior art just because they are included in this section, unless otherwise indicated expressly. Similarly, the problem mentioned in this section should not be considered to be universally recognized in any prior art, unless otherwise indicated expressly.

### SUMMARY

According to an aspect of the present disclosure, a method for training a multi-modal foundation model is provided, including: obtaining first urban data of a first sample urban region, where the first urban data comprises a plurality of first data segments that respectively correspond to a plurality of data modalities; inputting the first urban data into a multi-modal foundation model to obtain respective predicted vector representations output by the multi-modal foundation model for the plurality of first data segments; obtaining a plurality of general-purpose foundation models that are pre-trained, where each general-purpose foundation model of the plurality of general-purpose foundation models corresponds to at least one data modality of the plurality of data modalities; for each general-purpose foundation model of the plurality of general-purpose foundation models: generating a vector representation label of a first data segment of a corresponding data modality by using the general-purpose foundation model; and determining a knowledge distillation loss of the general-purpose foundation model based on the vector representation label and a predicted vector representation of the first data segment; determining an overall loss of the multi-modal foundation model based on at least respective knowledge distillation losses of the plurality of general-purpose foundation models; and adjusting parameters of the multi-modal foundation model based on the overall loss.

According to an aspect of the present disclosure, an electronic device is provided, including: a processor; and a memory communicatively connected to the processor; wherein the memory stores instructions executable by the processor, and the instructions, when executed by the processor, cause the processor to perform operations including: obtaining first urban data of a first sample urban region, where the first urban data comprises a plurality of first data segments that respectively correspond to a plurality of data modalities; inputting the first urban data into a multi-modal foundation model to obtain respective predicted vector representations output by the multi-modal foundation model for the plurality of first data segments; obtaining a plurality of general-purpose foundation models that are pre-trained, where each general-purpose foundation model of the plurality of general-purpose foundation models corresponds to at least one data modality of the plurality of data modalities; for each general-purpose foundation model of the plurality of general-purpose foundation models: generating a vector representation label of a first data segment of a corresponding data modality by using the general-purpose foundation model; and determining a knowledge distillation loss of the general-purpose foundation model based on the vector representation label and a predicted vector representation of the first data segment; determining an overall loss of the multi-modal foundation model based on at least respective knowledge distillation losses of the plurality of general-purpose foundation models; and adjusting parameters of the multi-modal foundation model based on the overall loss.

According to an aspect of the present disclosure, a non-transitory computer-readable storage medium is provided. The storage medium stores computer instructions which are configured to enable a computer to perform operations including: obtaining first urban data of a first sample urban region, where the first urban data comprises a plurality of first data segments that respectively correspond to a plurality of data modalities; inputting the first urban data into a multi-modal foundation model to obtain respective predicted vector representations output by the multi-modal foundation model for the plurality of first data segments; obtaining a plurality of general-purpose foundation models that are pre-trained, where each general-purpose foundation model of the plurality of general-purpose foundation models corresponds to at least one data modality of the plurality of data modalities; for each general-purpose foundation model of the plurality of general-purpose foundation models: generating a vector representation label of a first data segment of a corresponding data modality by using the general-purpose foundation model; and determining a knowledge distillation loss of the general-purpose foundation model based on the vector representation label and a predicted vector representation of the first data segment; determining an overall loss of the multi-modal foundation model based on at least respective knowledge distillation losses of the plurality of general-purpose foundation models; and adjusting parameters of the multi-modal foundation model based on the overall loss.

### BRIEF DESCRIPTION OF THE DRAWINGS

The accompanying drawings show example embodiments and form a part of the specification, and are used to explain example implementations of the embodiments together with a written description of the specification. The embodiments shown are merely for illustrative purposes and do not limit the scope of the claims. Throughout the accompanying drawings, the same reference numerals denote similar but not necessarily same elements.

FIG. 1 is a schematic diagram of an example system in which various methods described herein can be implemented according to embodiments of the present disclosure;

FIG. 2 is a flowchart of a multi-modal foundation model training method according to embodiments of the present disclosure;

FIG. 3 is a block diagram of a structure of a multi-modal foundation model according to embodiments of the present disclosure;

FIG. 4 is a schematic diagram of grid division manners based on different granularities and ordering results thereof according to embodiments of the present disclosure;

FIG. 5 is a schematic diagram of a multi-modal foundation model and a pre-training framework therefor according to embodiments of the present disclosure;

FIG. 6 is a flowchart of an urban region identification method according to embodiments of the present disclosure;

FIG. 7 is a block diagram of a structure of a multi-modal foundation model training apparatus according to embodiments of the present disclosure;

FIG. 8 is a block diagram of a structure of an urban region identification apparatus according to embodiments of the present disclosure; and

FIG. 9 is a block diagram of a structure of an example electronic device that can be used to implement embodiments of the present disclosure.

### DETAILED DESCRIPTION OF EMBODIMENTS

Example embodiments of the present disclosure are described below in conjunction with the accompanying drawings, where various details of the embodiments of the present disclosure are included to facilitate understanding, and should only be considered as example. Therefore, those of ordinary skill in the art should be aware that various changes and modifications can be made to the embodiments described here, without departing from the scope of the present disclosure. Likewise, for clarity and conciseness, the description of well-known functions and structures is omitted in the following description.

In the present disclosure, unless otherwise stated, the terms “first”, “second”, etc., used to describe various elements are not intended to limit the positional, temporal or importance relationship of these elements, but rather only to distinguish one element from the other. In some examples, a first element and a second element may refer to a same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of listed terms. “A plurality of” means two or more.

In the technical solutions of the present disclosure, collection, storage, use, processing, transmission, provision, disclosure, etc. of user personal information involved all comply with related laws and regulations and are not against the public order and good morals.

In the related art, a machine learning technology is usually used to handle an urban region identification task, for example, village-in-city identification, demolition region identification, high population density region identification, and economic index forecasting. Currently, most methods are designed for specific tasks. Specifically, a neural network model needs to be designed for a specific urban region identification task, supervised training is performed on the model by using a large amount of labeled data, and then, an urban region identification result is obtained by using a trained model. In practice, however, it is often difficult to obtain a large amount of labeled data. In this case, a model cannot learn enough urban knowledge from labeled data, resulting in low accuracy of an identification result. In addition, the model obtained through supervised training by using the labeled data for the specific task has poor generalization performance, and cannot be applied to another task (for example, a model obtained through training for identifying a village in a city cannot be used for predicting population density). For the other task, new labeled data is required to obtain a new model through retraining, resulting in low urban region identification efficiency, and difficulty of meeting diversified urban region identification requirements.

Foundation models (FMs) are models with strong representation capabilities that are widely applied to various artificial intelligence tasks and are obtained through pre-training based on large-scale data. In recent years, the foundation models have achieved remarkable results in the fields of natural language processing and computer vision. These foundation models can learn general knowledge from large-scale unlabeled data by using a self-supervised pre-training technology, to adapt to a wide range of downstream tasks.

However, foundation models in the general fields (for example, GPT, ViT, and CLIP) usually use conventional transformer architectures, and are trained based on plain texts and images. In structural design of these models, how to model a geospatial feature of urban data is not considered and no optimization objective is specifically designed for training based on the urban data, resulting in lack of knowledge of the geospatial field. Consequently, good performance cannot be achieved in related applications in the field of urban region identification, and accuracy is low.

In addition, the general knowledge and the generalization capabilities of the foundation models are obtained by pre-training the foundation models based on massive data. However, available urban data is limited, and usually, one urban region can be divided into only thousands to tens of thousands of regions. Even if data is collected from a plurality of cities, this data scale is still far less than that used for pre-training of a general-purpose foundation model. If retraining a foundation model dedicated for the urban region identification task based on the urban data, since the data scale for pre-training is not enough, a generalization capability of the model is greatly limited, resulting in low accuracy of urban region identification.

In view of this, in the embodiments of the present disclosure, a multi-modal foundation model that is used for the field of urban region identification and that can handle a wide range of downstream tasks is constructed, and a pre-training method for the multi-modal foundation model is provided by using a self-supervised pre-training paradigm. Knowledge distillation is performed on existing general-purpose foundation models for different data modalities, so that the multi-modal foundation model in the embodiments of the present disclosure can fully learn multi-modal knowledge under the teaching of a plurality of existing general-purpose foundation models, thereby improving generalization performance thereof, enabling the multi-modal foundation model to accurately understand multi-modal urban data, and further generating general-purpose vector representations that can comprehensively and accurately express urban region features. The comprehensive and accurate vector representations may be widely applied to a plurality of downstream tasks of urban region identification, thereby improving accuracy and efficiency of urban region identification.

In the embodiments of the present disclosure, a general-purpose foundation model that has good generalization capability and understanding capability and that is used for the field of urban region identification can be obtained by using only limited unlabeled data without obtaining a large amount of labeled data and designing and training complex models for different urban region identification tasks, thereby improving efficiency and accuracy of urban region identification.

The embodiments of the present disclosure will be described below in detail with reference to the accompanying drawings.

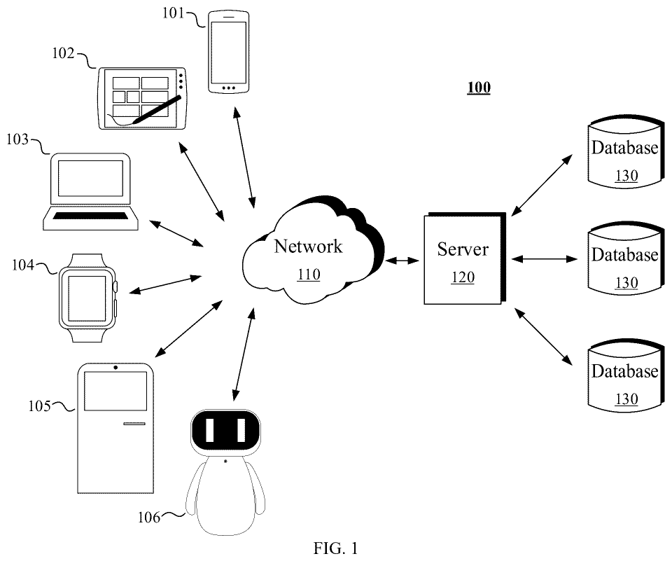

FIG. 1 is a schematic diagram of an example system 100 in which various methods and apparatuses described herein can be implemented according to embodiments of the present disclosure. Referring to FIG. 1, the system 100 includes one or more client devices 101, 102, 103, 104, 105, and 106, a server 120, and one or more communication networks 110 that couple the one or more client devices to the server 120. The client devices 101, 102, 103, 104, 105, and 106 may be configured to execute one or more applications.

In the embodiments of the present disclosure, the client devices 101, 102, 103, 104, 105, and 106 and the server 120 may run one or more services or software applications that can cause a multi-modal foundation model training method to be performed.

In some embodiments, the server 120 may further provide other services or software applications that may include a non-virtual environment and a virtual environment. In some embodiments, these services may be provided as web-based services or cloud services, for example, provided to a user of the client devices 101, 102, 103, 104, 105, and/or 106 in a software as a service (SaaS) model.

In the configuration shown in FIG. 1, the server 120 may include one or more components that implement functions performed by the server 120. These components may include software components, hardware components, or a combination thereof that can be executed by one or more processors. A user operating the client devices 101, 102, 103, 104, 105, and/or 106 may sequentially use one or more client applications to interact with the server 120, to use the services provided by these components. It should be understood that various different system configurations are possible, and may be different from that of the system 100. Therefore, FIG. 1 is an example of the system for implementing various methods described herein, and is not intended to be limiting.

The client devices 101, 102, 103, 104, 105, and/or 106 may provide an interface that enables the user of the client device to interact with the client device. The client device may also output information to the user via the interface. Although FIG. 1 shows only six client devices, those skilled in the art will understand that any number of client devices are supported in the present disclosure.

The client devices 101, 102, 103, 104, 105, and/or 106 may include various types of computer devices, for example, a portable handheld device, a general-purpose computer (for example, a personal computer and a laptop computer), a workstation computer, a wearable device, a smart screen device, a self-service terminal device, a service robot, a vehicle-mounted device, a gaming system, a thin client, various messaging devices, and a sensor or other sensing devices. These computer devices can run various types and versions of software application programs and operating systems, such as MICROSOFT Windows, APPLE IOS, a UNIX-like operating system, and a Linux or Linux-like operating system; or include various mobile operating systems, such as MICROSOFT Windows Mobile OS, iOS, Windows Phone, and Android. The portable handheld device may include a cellular phone, a smartphone, a tablet computer, a personal digital assistant (PDA), etc. The wearable device may include a head-mounted display (such as smart glasses) and other devices. The gaming system may include various handheld gaming devices, Internet-enabled gaming devices, etc. The client device can execute various applications, such as various Internet-related applications, communication applications (e.g., email applications), and short message service (SMS) applications, and can use various communication protocols.

The network 110 may be any type of network well known to those skilled in the art, and may use any one of a plurality of available protocols (including but not limited to TCP/IP, SNA, IPX, etc.) to support data communication. As a mere example, the one or more networks 110 may be a local area network (LAN), an Ethernet-based network, a token ring, a wide area network (WAN), the Internet, a virtual network, a virtual private network (VPN), an intranet, an extranet, a blockchain network, a public switched telephone network (PSTN), an infrared network, a wireless network (such as Bluetooth or Wi-Fi), and/or any combination of these and/or other networks.

The server 120 may include one or more general-purpose computers, a dedicated server computer (for example, a personal computer (PC) server, a UNIX server, or a terminal server), a blade server, a mainframe computer, a server cluster, or any other suitable arrangement and/or combination. The server 120 may include one or more virtual machines running a virtual operating system, or other computing architectures related to virtualization (e.g., one or more flexible pools of logical storage devices that can be virtualized to maintain virtual storage devices of a server). In various embodiments, the server 120 can run one or more services or software applications that provide functions described below.

A computing unit in the server 120 can run one or more operating systems including any of the above operating systems and any commercially available server operating system. The server 120 can also run any one of various additional server applications and/or middle-tier applications, including an HTTP server, an FTP server, a CGI server, a JAVA server, a database server, etc.

In some implementations, the server 120 may include one or more applications to analyze and merge data feeds and/or event updates received from users of the client devices 101, 102, 103, 104, 105, and/or 106. The server 120 may further include one or more applications to display the data feeds and/or real-time events via one or more display devices of the client devices 101, 102, 103, 104, 105, and/or 106.

In some implementations, the server 120 may be a server in a distributed system, or a server combined with a blockchain. The server 120 may alternatively be a cloud server, or an intelligent cloud computing server or intelligent cloud host with artificial intelligence technologies. The cloud server is a host product in a cloud computing service system, to overcome the shortcomings of difficult management and weak service scalability in conventional physical host and virtual private server (VPS) services.

The system 100 may further include one or more databases 130. In some embodiments, these databases can be used to store data and other information. For example, one or more of the databases 130 can be configured to store information such as an audio file and a video file. The databases 130 may reside in various positions. For example, a database used by the server 120 may be locally in the server 120, or may be remote from the server 120 and may communicate with the server 120 via a network-based or dedicated connection. The database 130 may be of different types. In some embodiments, the database used by the server 120 may be, for example, a relational database. One or more of these databases can store, update, and retrieve data from or to the database, in response to a command.

In some embodiments, one or more of the databases 130 may also be used by an application to store application data. The database used by the application may be of different types, for example, may be a key-value repository, an object repository, or a regular repository backed by a file system.

The system 100 of FIG. 1 may be configured and operated in various manners, so that the various methods and apparatuses described according to the present disclosure can be applied.

According to some embodiments, the server 120 may perform the multi-modal foundation model training method according to the embodiments of the present disclosure to obtain a pre-trained multi-modal foundation model that can handle a wide range of urban region identification tasks. In some cases, the multi-modal foundation model training method in the embodiments of the present disclosure may alternatively be performed by the client devices 101 to 106. This usually requires the client devices 101 to 106 to have high hardware configurations and computing capabilities.

An urban region identification method in the embodiments of the present disclosure may be implemented by using the trained multi-modal foundation model. Specifically, the users may specify urban regions to be identified by using the client devices 101 to 106. The client devices 101 to 106 or the server 120 may obtain urban data of the urban regions and obtain identification results of the urban regions by using the trained multi-modal foundation model. Further, the client devices 101 to 106 may output the identification results of the urban regions to the users.

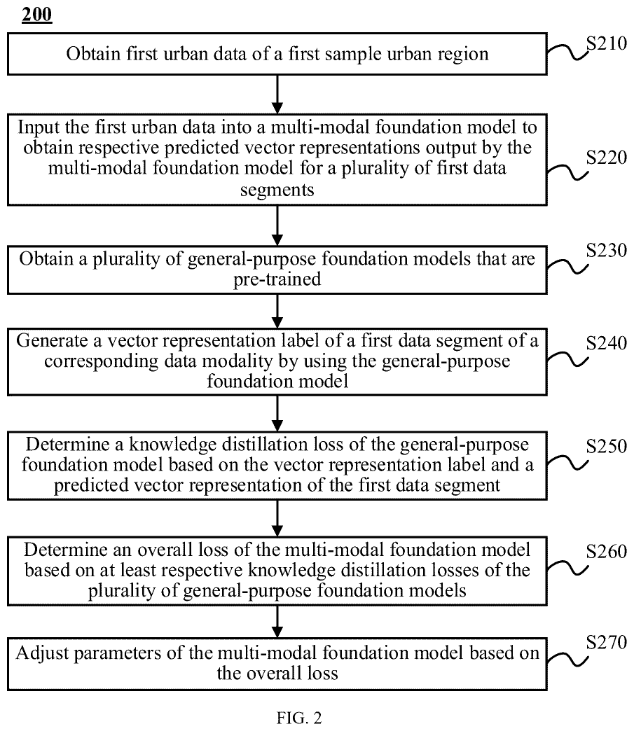

FIG. 2 is a flowchart of a multi-modal foundation model training method 200 according to embodiments of the present disclosure. An execution body of the method 200 may be a server, for example, the server 120 shown in FIG. 1, or may be a client device, for example, the client devices 101 to 106 shown in FIG. 1.

As shown in FIG. 2, the method 200 includes steps S210 to S270.

In step S210, first urban data of a first sample urban region is obtained. The first urban data includes a plurality of first data segments that respectively correspond to a plurality of data modalities.

In step S220, the first urban data is input into a multi-modal foundation model to obtain respective predicted vector representations output by the multi-modal foundation model for the plurality of first data segments.

In step S230, a plurality of general-purpose foundation models that are pre-trained are obtained. Each of the plurality of general-purpose foundation models corresponds to at least one of the plurality of data modalities.

For each of the plurality of general-purpose foundation models, the following steps S240 and S250 are performed.

In step S240, a vector representation label of a first data segment of a corresponding data modality is generated by using the general-purpose foundation model.

In step S250, a knowledge distillation loss of the general-purpose foundation model is determined based on the vector representation label and a predicted vector representation of the first data segment.

In step S260, an overall loss of the multi-modal foundation model is determined based on at least respective knowledge distillation losses of the plurality of general-purpose foundation models.

In step S270, parameters of the multi-modal foundation model are adjusted based on the overall loss.

According to embodiments of the present disclosure, a multi-modal foundation model that is used for the field of urban region identification and that can handle a wide range of downstream tasks is provided, and a pre-training method for the multi-modal foundation model is provided by using a self-supervised pre-training paradigm. Knowledge distillation is performed on existing general-purpose foundation models for different data modalities, so that the multi-modal foundation model in the embodiments of the present disclosure can fully learn multi-modal knowledge under the teaching of a plurality of existing general-purpose foundation models, thereby improving generalization performance thereof, enabling the multi-modal foundation model to accurately understand multi-modal urban data, and further generating general-purpose vector representations that can comprehensively and accurately express urban region features. The comprehensive and accurate vector representations may be widely applied to a plurality of downstream tasks of urban region identification, thereby improving accuracy and efficiency of urban region identification.

In the embodiments of the present disclosure, a general-purpose foundation model that has good generalization capability and understanding capability and that is used for the field of urban region identification can be obtained by using only limited unlabeled data without obtaining a large amount of labeled data and designing and training complex models for different urban region identification tasks, thereby improving efficiency and accuracy of urban region identification. The steps of the method 200 are described in detail below.

In step S210, first urban data of a first sample urban region is obtained. The first urban data includes a plurality of first data segments that respectively correspond to a plurality of data modalities.

According to some embodiments, first sample cities such as a city A and a city B may be determined as training data for the multi-modal foundation model first. For each first sample city, a geographic region in which the first sample city is located is divided according to a set division strategy to obtain a plurality of first sample urban regions. According to some embodiments, the geographic region in which the first sample city is located may be divided, in a grid-based manner, into a plurality of grids R={R₁, R₂, . . . , Rₙ} that are not overlapped with each other and have a same size (for example, Lᵣ×Lᵣ), where each grid Rᵢ (i=1, 2, . . . , n) is used as one first sample urban region. In some other embodiments, the geographic region in which the first sample city is located may alternatively be divided in another manner, for example, the first sample city is divided into a plurality of first sample urban regions based on a road network structure of the first sample city.

Different first sample urban regions have different urban data and therefore have different features. In the embodiments of the present disclosure, the urban data of the first sample urban region is denoted as first urban data.

The first urban data may be multi-modal, that is, the first urban data may include a plurality of first data segments, and each first data segment corresponds to one data modality.

The data modality refers to an existence form of data, for example, a text, an image, or an audio. In some embodiments, the data modality may alternatively be a data modality in an industrial scenario, for example, sensor data, an electrical signal, or an infrared signal. A same object may be described by using data of different modalities. The data of different modalities may have the same or similar semantics. For example, a name (text) of a specific restaurant “xx Restaurant” and a satellite image containing the restaurant (or a picture of the restaurant) are used to describe the restaurant, that is, the name text of the restaurant and the satellite image containing the restaurant have similar semantics.

According to some embodiments, the first urban data may include point-of-interest (POI) data of a text modality and image data of an image modality. The point-of-interest data and the image data are each a first data segment.

Points of interest refer to places in a map that provide various services, for example, a restaurant, a hospital, and a school. A specific first sample urban region Rᵢ usually includes a series of points of interest Pᵢ={Pᵢ₁, Pᵢ₂, . . . , Pᵢₘ}, where m is a quantity of points of interest in the first sample urban region Rᵢ. Each point of interest Pᵢⱼ (j=1, 2, . . . , m) may have three attributes: a name nameᵢⱼ, a category idᵢⱼ, and a geographic position locᵢⱼ. These attributes provide functional and spatial information of the point of interest to describe a possible human activity in the first sample urban region. Correspondingly, the point-of-interest data may include names, categories, and geographic positions of points of interest located in the first sample urban region.

The image data of the first sample urban region may be, for example, a satellite image. The satellite image is a top view of the first sample urban region, and contains rich geospatial information, for example, a spatial distribution of buildings and roads in the region, and land usage types. In some other embodiments, the image data of the first sample urban region may alternatively be pictures taken in different positions in the first sample urban region. The image data of the first sample urban region Rᵢ may be represented as Sᵢ.

According to some embodiments, in addition to the point-of-interest data and the image data, the first urban data may further include a first data segment of another modality, for example, sound signals and sensor signals (for example, a temperature, humidity, and a particulate matter concentration) in the first sample urban region.

After the first urban data of the first sample urban region is obtained through step S210, step S220 may be performed. The first urban data is input into a multi-modal foundation model to obtain respective predicted vector representations output by the multi-modal foundation model for the plurality of data segments.

In the embodiments of the present disclosure, the multi-modal foundation model is a general-purpose foundation model used for the field of urban region identification. The model can learn a vector representation of an urban region with rich semantics, and the vector representation may be used to handle various urban region identification tasks.

According to some embodiments, the multi-modal foundation model may include a plurality of unimodal encoders and one multi-modal transformer. Each unimodal encoder corresponds to one data modality of the first urban data, and is configured to encode a first data segment of the data modality. An input end of the multi-modal transformer is separately connected to an output end of each unimodal encoder, to fuse and update encoding outputs of the unimodal encoders to obtain a vector representation of each first data segment.

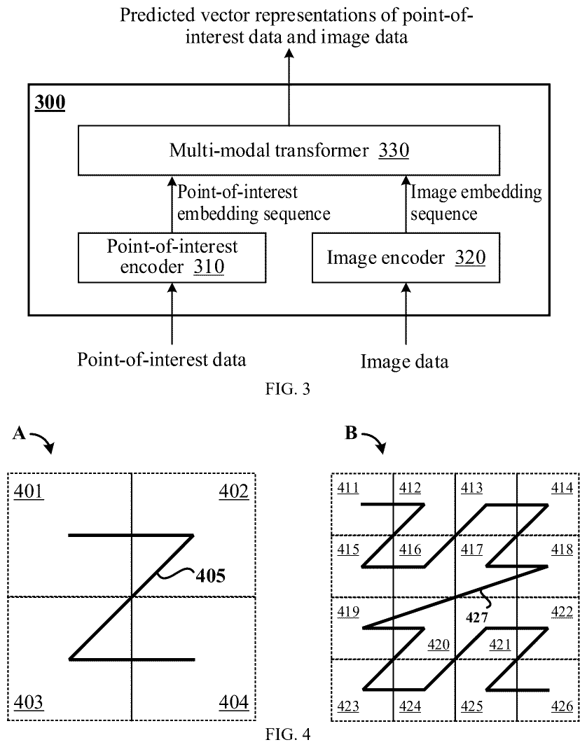

According to some embodiments, as shown in FIG. 3, when the first urban data includes the point-of-interest data of the text modality and the image data of the image modality, a multi-modal foundation model 300 may include a point-of-interest encoder 310 configured to encode the point-of-interest data, an image encoder 320 configured to encode the image data, and a multi-modal transformer 330 configured to fuse and update a point-of-interest encoding result and an image encoding result. Correspondingly, step S220 may include steps S221 to S223.

In step S221, the point-of-interest data is input into the point-of-interest encoder 310, to obtain an encoding result of the point-of-interest data, that is, a point-of-interest embedding sequence. The point-of-interest embedding sequence includes an embedding of each point-of-interest data unit in the point-of-interest data.

In step S222, the image data is input into the image encoder 320, to obtain an encoding result of the image data, that is, an image embedding sequence. The image embedding sequence includes an embedding of each image data unit in the image data.

In step S223, the point-of-interest embedding sequence and the image embedding sequence are input into the multi-modal transformer 330, so that the multi-modal transformer 330 fuses and updates the point-of-interest embedding sequence and the image embedding sequence to obtain a predicted vector representation of the point-of-interest data and a predicted vector representation of the image data.

In the embodiments of the present disclosure, a data unit is a basic unit for data processing by the multi-modal foundation model. For the point-of-interest data of the text modality, the point-of-interest data units may be tokens obtained by tokenizing a point-of-interest text, for example, tokens obtained by tokenizing a point-of-interest name sequence. For the image data of the image modality, the image data units may be image patches obtained by dividing an image.

According to some embodiments, the point-of-interest data includes respective names, geographic positions, and categories of a plurality of points of interest located in the first sample urban region. Correspondingly, step S221 may include: inputting the point-of-interest data into the point-of-interest encoder, so that the point-of-interest encoder performs the following steps S2211 and S2212.

In step S2211, the respective names of the points of interest are represented as a point-of-interest name sequence. Each token in the point-of-interest name sequence is used as one point-of-interest data unit.

In step S2212, for each token in the point-of-interest name sequence, an embedding of the token is generated based on at least one of: the token, and a geographic position of a point of interest corresponding to the token, or a category of the point of interest corresponding to the token.

According to the above embodiment, embeddings of tokens in the point-of-interest name sequence may be flexibly generated based on the names, the geographic positions, and the categories of the points of interest.

In step S2211, the names of the points of interest are combined to obtain the point-of-interest name sequence.

According to some embodiments, in step S2211, the points of interest in the first sample urban region may be ordered according to a set point-of-interest ordering strategy to obtain a point-of-interest sequence. Further, the names of the points of interest in the point-of-interest sequence are combined and tokenized to obtain the point-of-interest name sequence. The set point-of-interest ordering strategy may be, for example, random ordering, ordering according to initial letters of the names of the points of interest, or ordering according to sizes of coordinates of the geographic positions of the points of interest.

According to some embodiments, step S2211 may include steps S22111 to S22113.

In step S22111, the plurality of points of interest are ordered based on a relative distance between the plurality of points of interest, to obtain the point-of-interest sequence.

In step S22112, the names of the points of interest in the point-of-interest sequence are combined to obtain a point-of-interest name pseudo sentence.

In step S22113, the point-of-interest name pseudo sentence is tokenized to obtain the point-of-interest name sequence.

According to the above embodiment, the points of interest are first ordered based on the relative distance between the points of interest, and then the point-of-interest name sequence is generated based on the names of the ordered points of interest, so that the point-of-interest name sequence can express a spatial positional relationship (relative distance) between the points of interest and functions of the points of interest (reflected by the names of the points of interest), thereby increasing an amount of information in the point-of-interest name sequence, causing the point-of-interest encoder to generate a point-of-interest embedding sequence that can comprehensively and accurately express features of points of interest of a region, and improving expression and understanding capabilities of the multi-modal foundation model for an urban region.

According to some embodiments, step S22111 may include: dividing the first sample urban region into a plurality of grids of a same size, where the plurality of grids form a plurality of grid pairs, each of the plurality of grid pairs includes two adjacent grids; ordering the plurality of grids according to a set ordering strategy to obtain a grid sequence, where two grids in some of the plurality of grid pairs are adjacent in the grid sequence; and separately obtaining a point of interest located in each grid in the grid sequence to obtain the point-of-interest sequence.

According to the above embodiment, the points of interest are ordered through grid division and serialization, to improve calculation efficiency during ordering of the points of interest.

A size of the grid may be set as required. According to some embodiments, to improve precision of ordering of the points of interest, the first sample urban region may be divided into grids of a fine granularity, for example, the size of the grid may be 1 m*1 m, 1 m*2 m, or 2 m*2 m.

Each grid pair includes two grids that are geographically adjacent. For different grid division manners, grid pair identification manners may be different.

For example, when the first sample urban region is divided into a plurality of rectangular grids that are not overlapped with each other, adjacent grids of a specific grid may be determined based on four neighborhoods, that is, the adjacent grids of the specific grid are four grids located above (north), below (south), to the left (west), and to the right (east) of the grid. Therefore, four grid pairs are obtained. Further, adjacent grids of a specific grid may be determined based on eight neighborhoods, that is, the adjacent grids of the specific grid are eight grids located above (north), below (south), to the left (west), to the right (east), to the upper-left (northwest), to the lower-left (southwest), to the upper-right (northeast), and to the lower-right (southeast) of the grid. Therefore, eight grid pairs are obtained.

When the first sample urban region is divided, based on road network data, into a plurality of grids that are not overlapped with each other, two grids in which a quantity of intersections through which a communication path passes is less than an intersection threshold are used as two adjacent grids. For example, a grid 1 and a grid 2 are connected by a path, the path passes through three intersections, which is less than an intersection threshold 5. Therefore, the grid 1 and the grid 2 are determined to be adjacent, and form a grid pair (grid 1, grid 2).

After the first sample urban region is divided into the plurality of grids, the plurality of grids are further serialized, that is, the plurality of grids are ordered according to the set ordering strategy to obtain the grid sequence. In the grid sequence, two grids that are geographically close are usually ordered to be adjacent. It should be noted that none of current geographic ordering strategies can completely maintain an adjacent relationship in two-dimensional geographic space, that is, it cannot be ensured that any two adjacent grids in the geographic space are adjacent in an ordering result. Actually, in the ordering result of the grids, only two grids in some of the grid pairs (each including two grids that are physically geographically adjacent) still remain adjacent in the grid sequence. Two grids in the remaining grid pairs are not adjacent in the grid sequence, or even far apart.

The ordering strategy for the grids may be set as required. For example, an ordering strategy based on a Z-shaped curve (Z-ordering), an ordering strategy based on a Hilbert curve (Hilbert-ordering), or the like may be used.

FIG. 4 is a schematic diagram of grid division manners A and B based on different granularities and corresponding Z-ordering results.

In the grid division manner A, the first sample urban region is divided into four grids of a size of a*a, that is, grids 401 to 404. The grids 401 to 404 are ordered based on a Z-shaped curve 405 to obtain a grid sequence {401, 402, 403, 404}. The grids 401 and 402 are adjacent in actual geographic space and are also adjacent in the grid sequence. However, the grids 401 and 403 are adjacent in the actual geographic space, but not adjacent in the grid sequence.

Similarly, in the grid division manner B, the same first sample urban region is divided into 16 grids of a size of (a/2)*(a/2), that is, grids 411 to 426. The grids 411 to 426 are ordered based on a Z-shaped curve 427 to obtain a grid sequence {411, 412, 415, 416, 413, 414, 417, 418, 419, 420, 423, 424, 421, 422, 425, 426}. The grids 415 and 416 are adjacent in the actual geographic space and are also adjacent in the grid sequence. However, the grids 415 and 419 are adjacent in the actual geographic space, but are not adjacent in the grid sequence or even far apart (five grids exist therebetween).

After the grid sequence is obtained, the points of interest in the first sample urban region are ordered based on the grids in which the points of interest are located, and the obtained point-of-interest sequence can reflect the relative distance between the points of interest. Specifically, the point-of-interest sequence may be initialized as an empty sequence. For each grid in the grid sequence, a point of interest located in the grid is obtained, and the point of interest is added to the point-of-interest sequence until the grids in the grid sequence are traversed. In some cases, a plurality of geographically close points of interest may be located in a same grid. In this case, these points of interest may be randomly ordered and added to the point-of-interest sequence. Because a grid division granularity is usually fine (for example, 1 m*1 m), random ordering of the plurality of points of interest in the same grid has little impact on the vector representation of the urban region.

After the point-of-interest sequence is obtained through step S22111, in step S22112, the names of the points of interest in the point-of-interest sequence are combined, to obtain the point-of-interest name pseudo sentence.

Subsequently, in step S22113, the point-of-interest name pseudo sentence is tokenized to obtain the point-of-interest name sequence.

According to some embodiments, a separator [SEP] is further added after a last token of each point of interest based on a tokenization result. The separator [SEP] is a set special token used to separate different points of interest. When the separator [SEP] is added after the last token of each point of interest, the separator [SEP] is considered to belong to a point of interest located before the separator [SEP].

In some other embodiments, the separator [SEP] may alternatively be added before a first token of each point of interest. In this case, the separator [SEP] is considered to belong to a point of interest located after the separator [SEP].

After the point-of-interest name sequence is obtained through step S2211 (including the steps S22111 to S22113), step S2212 may be performed. In step S2212, for each token in the point-of-interest name sequence, an embedding of the token is generated based on at least one of the token and a geographic position and a category of a point of interest corresponding to the token.

According to some embodiments, in step S2212, for each token in the point-of-interest name sequence, the embedding of the token may be generated based on the token and the geographic position and the category of the point of interest corresponding to the token. Specifically, step S2212 may include steps S22121 to S22124.

In step S22121, the token is encoded to obtain a word embedding of the token.

In step S22122, a geographic position embedding of the token is generated based on the geographic position of the point of interest corresponding to the token.

In step S22123, the category of the point of interest corresponding to the token is encoded to obtain a category embedding of the token.

In step S22124, the embedding of the token is determined based on the word embedding, the geographic position embedding, and the category embedding.

According to the above embodiment, the embedding of each token can comprehensively and accurately express data of a corresponding point of interest, thereby improving accuracy of the embedding of the token, and improving accuracy of urban region identification.

According to some embodiments, in step S22121, a word embedding table E″ ( ) may be used to map the token as a word embedding in latent space. The word embedding table E″ ( ) stores a mapping relationship between the token and the word embedding. The word embedding table E″ ( ) may be a trainable parameter of the multi-modal foundation model.

According to some embodiments, in step S22122, a plurality of pieces of position information of different granularities may be obtained for the token based on the geographic position of the point of interest corresponding to the token; and the geographic position embedding of the token is generated based on the plurality of pieces of position information. According to this embodiment, the position information of different granularities is encoded, so that the geographic position embedding of each token can comprehensively and accurately express the position information thereof, thereby improving accuracy of the embedding of the token.

According to some embodiments, the plurality of pieces of position information of different granularities of the token include a first position of the token in a name of a corresponding point of interest, a second position of the point of interest in the point-of-interest sequence corresponding to the point-of-interest name sequence, and a grid in which the point of interest is located. The grid is obtained through average division of the first sample urban region. Correspondingly, the geographic position embedding of the token may be obtained through the following steps: encoding the first position to obtain a word position embedding of the token; encoding the second position to obtain a point-of-interest position embedding of the token; encoding an identifier of the grid to obtain a grid position embedding of the token; and fusing the word position embedding, the point-of-interest position embedding, and the grid position embedding to obtain the geographic position embedding of the token.

According to the above embodiment, geographic position embeddings of tokens are generated at a word level, a POI level, and a grid level, so that the geographic position embeddings can express a complex sequence relationship between the tokens and express the spatial positional relationship between the points of interest, thereby improving accuracy and comprehensiveness of the geographic position embeddings.

According to some embodiments, a word position embedding table E^{wp}( ) may be used to map the first position of the token in the name of the corresponding point of interest as the word position embedding. The word position embedding table E^{wp}( ) stores a mapping relationship between the first position and the word position embedding. The word position embedding table E^{wp}( ) may be a trainable parameter of the multi-modal foundation model.

According to some embodiments, a point-of-interest position embedding table E^{pp}( ) may be used to map the second position of the point of interest to which the token belongs in the point-of-interest sequence as the point-of-interest position embedding. The point-of-interest position embedding table E^{pp}( ) stores a mapping relationship between the second position and the point-of-interest position embedding. The point-of-interest position embedding table E^{pp}( ) may be a trainable parameter of the multi-modal foundation model.

According to some embodiments, a grid position embedding table E^{gp}( ) may be used to map the identifier of the grid in which the point of interest to which the token belongs is located as the grid position embedding. The grid position embedding table E^{gp}( ) stores a mapping relationship between the identifier of the grid and the grid position embedding. The grid position embedding table E^{gp}( ) may be a trainable parameter of the multi-modal foundation model.

The word position embedding, the point-of-interest position embedding, and the grid position embedding of the token are fused to obtain the geographic position embedding of the token. The word position embedding, the point-of-interest position embedding, and the grid position embedding may be fused in a plurality of manners. For example, the word position embedding, the point-of-interest position embedding, and the grid position embedding of the token may be fused into the geographic position embedding of the token in manners such as summation, averaging, weighted averaging, and concatenation.

According to some embodiments, in step S22123, a category embedding table E^{c}( ) may be used to map the category of the point of interest to which the token belongs as the category embedding. The category embedding table E^{c}( ) stores a mapping relationship between the category of the point of interest and the category embedding. The category embedding table E^{c}( ) may be a trainable parameter of the multi-modal foundation model.

According to some embodiments, in step S22124, a sum of the word embedding, the geographic position embedding, and the category embedding of the token may be used as the embedding of the token. In some other embodiments, an average value, a weighted summation result, a concatenation result, or the like of the word embedding, the geographic position embedding, and the category embedding may alternatively be used as the embedding of the token.

According to some embodiments, in step S22124, a modality embedding table E^{m}( ) may be used to map a data modality (the text modality, which may also be understood as a POI modality) corresponding to the token as a modality embedding. The modality embedding table E^{m}( ) stores a mapping relationship between the data modality and the modality embedding. The modality embedding table E^{m}( ) may be a trainable parameter of the multi-modal foundation model. Further, the embedding of the token may be determined based on the word embedding, the geographic position embedding, the category embedding, and the modality embedding of the token. For example, a sum, an average value, a concatenation result, or the like of the word embedding, the geographic position embedding, the category embedding, and the modality embedding is used as the embedding of the token.

According to some embodiments, step S222 may include: inputting the image data into the image encoder, so that the image encoder performs the following steps S2221 and S2222.

In step S2221, the image data is split into a plurality of image patches of a same size, and each image patch is one image data unit.

In step S2222, linear transformation is performed on each image patch in the image data to obtain an embedding of the image patch.

For example, the image data may be a satellite image with a height of H and a width of W that contains three color channels of R, G, and B, that is, a size of the image data is H*W*3. A size of the image patch may be, for example, s*s*3. Correspondingly, the image data may be divided into (H*W)/(s*s) image patches, each image patch includes pixel values of s*s pixels in the R, G, and B channels, which may be represented as an s*s*3-dimensional vector. The vector is mapped as a d-dimensional vector by using a linear transformation matrix, and the d-dimensional vector is used as the embedding of the image patch. The linear transformation matrix (including a plurality of weights) may be a trainable parameter of the multi-modal foundation model.

According to some embodiments, a 1-D position encoding and a modality embedding may be further added to each image patch after the embedding of each image patch is obtained. The embedding, the 1-D position encoding, and the modality embedding of each image patch constitute the image embedding sequence.

A 1-D position encoding manner is an encoding manner that considers one-dimensional position information. The 1-D position encoding of the image patch indicates a position (serial number) of the image patch in the image embedding sequence. According to some embodiments, a 1-D position embedding table E^{1D}( ) may be used to map the serial number of the image patch in the image embedding sequence as the 1-D position encoding. The 1-D position embedding table E^{1D}( ) stores a mapping relationship between the serial number of the image patch and the 1-D position encoding thereof. The 1-D position embedding table E^{1D}( ) may be a trainable parameter of the multi-modal foundation model.

The modality embedding indicates a data modality of the image patch, that is, the image modality. According to some embodiments, the modality embedding table E^{m}( ) may be used to map the data modality (that is, the image modality) corresponding to the image patch as a modality embedding. The modality embedding table E^{m}( ) stores a mapping relationship between the data modality and the modality embedding. The modality embedding table E^{m}( ) may be a trainable parameter of the multi-modal foundation model.

In step S230, a plurality of general-purpose foundation models that are pre-trained are obtained. Each of the plurality of general-purpose foundation models corresponds to at least one of the plurality of data modalities.

The general-purpose foundation models (FMs) are foundation models that are commonly applied to various application fields for processing and representing data of a specific modality. The data modality corresponding to the general-purpose foundation model is a data modality that the general-purpose foundation model can process.

According to some embodiments, a data modality set formed by data modalities corresponding to the general-purpose foundation models covers the plurality of data modalities included in the first urban data. Therefore, understanding and representation capabilities of the multi-modal foundation model of embodiments of the present disclosure for multi-modal urban data can be comprehensively enhanced by using the plurality of general-purpose foundation models.

According to some embodiments, the general-purpose foundation models obtained in step S230 may include unimodal general-purpose foundation models, for example, a language foundation model corresponding to the text modality and a visual foundation model corresponding to the image modality. The general-purpose foundation models may further include a cross-modal general-purpose foundation model, for example, a visual-language foundation model. The cross-modal general-purpose foundation model maps data of different modalities to the same feature space.

The language foundation model (Language FM) is a large language model (LLM) (also referred to as a large-scale language model or a large model). The large language model is a deep learning model trained by using a large amount of text data, and can implement understanding and generation of a natural language text. A quantity of model parameters of the large language model may reach an order of magnitude of tens of billions, an order of magnitude of hundreds of billions, or even a higher order of magnitude. According to some embodiments, the large language model may use a decoder-only structure. The large language model of the decoder-only structure includes only a decoder in a transformer structure, and does not include an encoder. The large language model of the decoder-only structure usually has good performance on a text generation task. According to some other embodiments, the large language model may alternatively use a transformer structure including an encoder and a decoder. The large language model may be, for example, an ERNIE Bot model or a generative pre-trained transformer (GPT) model.

The visual foundation model (Visual FM) is configured to understand an image to generate a vector representation of the image. The visual foundation model may be, for example, a vision transformer (ViT) model.

The visual-language foundation model is configured to understand a text and an image, map the text and the image to the same encoding feature space, to obtain vector representations of the text and the image. The visual-language foundation model may be, for example, a contrastive language-image pre-training (CLIP) model.

According to some embodiments, for each data modality in the first urban data, a unimodal general-purpose foundation model for processing the data modality is obtained. For each data modality pair (including two data modalities) in the first urban data, a cross-modal general-purpose foundation model for processing the data modality pair is obtained. Therefore, the understanding and representation capabilities of the multi-modal foundation model for urban data of each modality can be enhanced by using the unimodal general-purpose foundation models, and a semantic alignment capability of the multi-modal foundation model for the multi-modal urban data can be enhanced by using the cross-modal general-purpose foundation models.

For each of the plurality of general-purpose foundation models obtained in step S230, the following steps S240 and S250 are performed.

In step S240, a vector representation label of a first data segment of a corresponding data modality is generated by using the general-purpose foundation model.

According to some embodiments, for the language foundation model of the text modality, a vector representation label of the point-of-interest data of the text modality may be generated by using the language foundation model. Specifically, at least part of the point-of-interest data may be input into the language foundation model (for example, only the names of the points of interest are input, or all the point-of-interest data including the names, the categories, and the geographic positions of the points of interest are input) to obtain a description text generated by the language foundation model for the first sample urban region. The description text is used to describe a function and a possible resident activity of the first sample urban region. Then, the description text is encoded to obtain the vector representation label of the point-of-interest data.

For example, a point-of-interest set [symbol] of the first sample urban region is given, and a prompt text P is generated for the language foundation model based on the names of the points of interest and a set prompt template. The prompt text [symbol] may be, for example, “There are the following facilities in the region: POI1, POI2, . . . . Please infer a function and a possible resident activity of the region”. The prompt text [symbol] is input into the language foundation model, and the language foundation model uses the prompt text to generate the description text P̅ of the first sample urban region. Then, the description text may be encoded into a vector by using a sentence embedding model, and the vector is the vector representation label of the point-of-interest data. A process of encoding the description text may be described as the following formula:

$${u}_{P} = SenEmb ( \overline{ℙ} ) \qquad ( 1 )$$

where u_{P} is the vector representation label of the point-of-interest data, and SenEmb( ) represents an encoding process of the sentence embedding model.

According to some embodiments, for the visual foundation model of the image modality, a vector representation label of the image data of the image modality may be generated by using the visual foundation model. Specifically, the image data may be input into the visual foundation model to obtain the vector representation label output by the visual foundation model for the image data. A process of generating the vector representation label of the image data by using the visual foundation model may be expressed as the following formula:

$${u}_{S} = VFM ( S ) \qquad ( 2 )$$

where u_{S} is the vector representation label of the image data, and VFM( ) is an encoding process of the visual foundation model.

According to some embodiments, for the visual-language foundation model of an image-text modality, a vector representation label of the point-of-interest data of the text modality and a vector representation label of the image data of the image modality may be generated by using the visual-language foundation model. Specifically, the point-of-interest data and the image data may be separately input into the visual-language foundation model to obtain the respective vector representation labels output by the visual-language foundation model for the point-of-interest data and the image data.

In step S250, a knowledge distillation loss of the general-purpose foundation model is determined based on the vector representation label and a predicted vector representation of the first data segment.

According to some embodiments, knowledge distillation losses of the unimodal general-purpose foundation models (for example, the language foundation model and the visual foundation model) may be determined through steps S251 to S253.

In step S251, linear transformation is performed on the predicted vector representation of the first data segment to obtain a transformed predicted vector representation.

In step S252, a similarity between the transformed predicted vector representation and the vector representation label is calculated. The similarity may be, for example, a cosine similarity.

In step S253, a unimodal knowledge distillation loss of the unimodal general-purpose foundation model is determined based on the similarity, where the unimodal knowledge distillation loss is negatively correlated with the similarity. That is, a greater similarity between the transformed predicted vector representation and the vector representation label indicates a smaller value of the unimodal knowledge distillation loss.

According to the above embodiment, the predicted vector representation can be mapped to the same feature space as the vector representation label through linear transformation. Determining the unimodal knowledge distillation loss based on the similarity between the transformed predicted vector representation and the vector representation label can enhance the understanding and expression capabilities of the multi-modal foundation model for unimodal urban data by using the unimodal general-purpose foundation model.

According to some embodiments, the unimodal knowledge distillation loss [symbol] _{DLFM} of the language foundation model may be calculated according to the following formula:

$${ℒ}_{DLFM} = - Cos ( {σ}_{POI} ( {h}_{[ P ]} ) , {u}_{P} ) \qquad ( 3 )$$

where h_{[P]} is the predicted vector representation generated by the multi-modal foundation model for the point-of-interest data, u_{P} is the vector representation label generated by the language foundation model for the point-of-interest data, σ_{POI}( ) is a linear transformation function of the point-of-interest data, and Cos( ) is a calculation function of the cosine similarity.

According to some embodiments, the unimodal knowledge distillation loss [symbol] _{DVFM} of the visual foundation model may be calculated according to the following formula:

$${ℒ}_{DVFM} = - Cos ( {σ}_{Sate} ( {h}_{[ S ]} ) , {u}_{S} ) \qquad ( 4 )$$

where h_{[S]} is the predicted vector representation generated by the multi-modal foundation model for the image data, u_{S} is the vector representation label generated by the visual foundation model for the image data, σ_{Sate}( ) is a linear transformation function of the image data, and Cos( ) is a calculation function of the cosine similarity.

According to some embodiments, a knowledge distillation loss of the cross-modal general-purpose foundation model (for example, the visual-language foundation model) may be determined through steps S254 to S257. Data modalities corresponding to the cross-modal general-purpose foundation model are denoted as a first data modality and a second data modality.

In step S254, a first predicted vector representation and a first vector representation label of first data and a second predicted vector representation and a second vector representation label of second data of the first sample urban region are obtained. The first data is a first data segment corresponding to the first data modality and the second data is a first data segment corresponding to the second data modality.

The first predicted vector representation and the second predicted vector representation may be obtained from output of the multi-modal foundation model. The first vector representation label and the second vector representation label may be obtained from output of the cross-modal general-purpose foundation model. That is, the first vector representation label and the second vector representation label may be obtained by inputting the first data and the second data into the cross-modal general-purpose foundation model.

In step S255, a predicted similarity matrix is generated based on respective first predicted vector representations and second predicted vector representations of a plurality of first sample urban regions. An element in an i^{th} row and a j^{th} column in the predicted similarity matrix indicates a similarity between a first predicted vector representation of a first sample urban region i and a second predicted vector representation of a first sample urban region j.

The first predicted vector representation and the second predicted vector representation of each of the plurality of first sample urban regions may be obtained as recited in step S254. A quantity of first sample urban regions is denoted as B, and a predicted similarity matrix M̅ of a size of B*B may be obtained by calculating the similarity between the first predicted vector representation of the first sample urban region i (i=1, 2, . . . , B) and the second predicted vector representation of the first sample urban region j (j=1, 2, . . . , B). The similarity may be, for example, a cosine similarity.

In step S256, a similarity matrix label is generated based on respective first vector representation labels and second vector representation labels of the plurality of first sample urban regions. An element in an i^{th} row and a j^{th} column in the similarity matrix label indicates a similarity between a first vector representation label of the first sample urban region i and a second vector representation label of the first sample urban region j.

The first vector representation label and the second vector representation label of each of the plurality of first sample urban regions may be obtained as recited in step S254. A quantity of first sample urban regions is denoted as B, and a similarity matrix label M of a size of B*B may be obtained by calculating the similarity between the first vector representation label of the first sample urban region i (i=1, 2, . . . , B) and the second vector representation label of the first sample urban region j (j=1, 2, . . . , B). The similarity may be, for example, a cosine similarity.

In step S257, a cross-modal knowledge distillation loss of the cross-modal general-purpose foundation model is determined based on a dissimilarity between the predicted similarity matrix and the similarity matrix label, where the cross-modal knowledge distillation loss is positively correlated with the dissimilarity, that is, a greater dissimilarity between the predicted similarity matrix and the similarity matrix label indicates a greater cross-modal knowledge distillation loss, and a smaller dissimilarity between the predicted similarity matrix and the similarity matrix label indicates a smaller cross-modal knowledge distillation loss. The dissimilarity between the predicted similarity matrix and the similarity matrix label may be represented by, for example, Kullback-Leibler (KL) divergence of corresponding rows and corresponding columns in the two matrices.

According to the above embodiment, the semantic alignment capability of the multi-modal foundation model for the multi-modal urban data can be enhanced by using the cross-modal general-purpose foundation model.

According to some embodiments, the cross-modal general-purpose foundation model is the visual-language foundation model. Correspondingly, the first data modality is the text modality, the first data is the point-of-interest data of the text modality, the second data modality is the image modality, and the second data is the image data of the image modality. The cross-modal knowledge distillation loss [symbol] _{DVLFM} of the visual-language foundation model may be calculated according to the following formula:

$${ℒ}_{DVLFM} = {\sum }_{1 \leq i \leq B} KL ( ρ ( {\overline{M}}_{i} ) ‖ ρ ( {M}_{i} ) ) + {\sum }_{1 \leq j \leq B} KL ( ρ ( {\overline{M}}_{j}^{T} ) ‖ ρ ( {M}_{j}^{T} ) ) \qquad ( 5 )$$

where B is the quantity of first sample urban regions, M and M̅ are respectively the similarity matrix label and the predicted similarity matrix, Mᵢ and M̅ᵢ are respectively the i^{th} rows in the similarity matrix label and the predicted similarity matrix, Mⱼ^{T} and M̅ⱼ^{T} are respectively the j^{th} columns in the similarity matrix label and the predicted similarity matrix, ρ( ) is a softmax function used to transform rows or columns of a matrix into a probability distribution, and KL( ) is a calculation function of the KL divergence.

In step S260, an overall loss of the multi-modal foundation model is determined based on at least respective knowledge distillation losses of the plurality of general-purpose foundation models.

According to some embodiments, the overall loss of the multi-modal foundation model may be, for example, a weighted sum of the respective knowledge distillation losses of the general-purpose foundation models.

For example, when the plurality of general-purpose foundation models include the language foundation model, the visual foundation model, and the visual-language foundation model, the overall loss [symbol] of the multi-modal foundation model may be a sum of the knowledge distillation losses of the general-purpose foundation models (weights of the three knowledge distillation losses are all 1), that is,

$$ℒ = {ℒ}_{DLFM} + {ℒ}_{DVFM} + {ℒ}_{DVLFM} \qquad ( 6 )$$

where [symbol] _{DLFM}, [symbol] _{DVFM}, [symbol] _{DVLFM} are respectively the knowledge distillation losses of the language foundation model, the visual foundation model, and the visual-language foundation model. For calculation manners of the three knowledge distillation losses, refer to Formulas (3) to (5).

According to some embodiments, in addition to the knowledge distillation losses, the overall loss of the multi-modal foundation model may further include a loss of a self-supervised learning task.

As described above, each first data segment in the first urban data may be split into a plurality of data units, for example, the point-of-interest data may be split into a plurality of point-of-interest data units (that is, tokens), and the image data may be split into a plurality of image data units (that is, image patches).

According to some embodiments, the loss of the self-supervised learning task may include a mask loss. The mask loss may be calculated through the following steps S281 to S284.

In step S281, for each of the plurality of first data segments, at least one data unit in the first data segment is separately replaced with a set mask data unit to obtain masked first urban data. For example, some tokens (for example, 15% of the tokens) in the point-of-interest data may be replaced with set mask tokens [M], and some image patches (for example, 40% of the image patches) in the image data may be replaced with blank image patches, to obtain the masked first urban data.

In step S282, the masked first urban data is input into the multi-modal foundation model to obtain a vector representation output by the multi-modal foundation model for each data unit in the masked first urban data.

In step S283, for each masked data unit, a first probability of correctly predicting an unmasked data unit corresponding to the masked data unit based on a vector representation of the masked data unit is determined by using a first classifier. Specifically, a vector representation of the masked data unit is input into the first classifier to obtain the first probability output by the first classifier. The first classifier may include, for example, a two-layer multi-layer perceptron (MLP) and a softmax layer.

In step S284, a mask loss of the multi-modal foundation model is determined based on the first probability corresponding to each masked data unit.

According to some embodiments, when the first urban data includes the point-of-interest data and the image data, the mask loss [symbol] _{MGDM} may be calculated according to the following formula:

$${ℒ}_{MGDM} = - {\sum }_{i ∈ {ℳ}_{P}} log p ( {y}_{i}^{P} \vert {h}_{i} ) - {\sum }_{i ∈ {ℳ}_{S}} log p ( {y}_{i}^{S} \vert {h}_{i} ) \qquad ( 7 )$$

where [symbol] and [symbol] respectively represent positions of masked point-of-interest token and image patch, p(yᵢ^{P})|hᵢ) represents a first probability of correctly predicting, based on a vector representation hᵢ of an i^{th} masked point-of-interest token, an unmasked token yᵢ^{P} in this position, and p(yᵢ^{S}|hᵢ) represents a first probability of correctly predicting, based on a vector representation hᵢ of an i^{th} masked image patch, an unmasked image patch yᵢ^{S} in this position. The first probability is obtained by using the first classifier.

According to some embodiments, in step S260, the overall loss of the multi-modal foundation model may be determined based on the respective knowledge distillation losses of the plurality of general-purpose foundation models and the mask loss. The overall loss of the multi-modal foundation model may be, for example, a weighted sum of the respective knowledge distillation losses of the general-purpose foundation models and the mask loss.

For example, when the plurality of general-purpose foundation models include the language foundation model, the visual foundation model, and the visual-language foundation model, the overall loss [symbol] of the multi-modal foundation model may be a sum of the knowledge distillation losses of the general-purpose foundation models and the mask loss (weights of the four losses are all 1), that is,

$$ℒ = {ℒ}_{DLFM} + {ℒ}_{DVFM} + {ℒ}_{DVLFM} + {ℒ}_{MGDM} \qquad ( 8 )$$

where [symbol] _{DLFM}, [symbol] _{DVFM}, [symbol] _{DVLFM} are respectively the knowledge distillation losses of the language foundation model, the visual foundation model, and the visual-language foundation model, and [symbol] _{MGDM} is the mask loss. For calculation manners of the four losses, refer to Formulas (3) to (5) and (7).

According to the above embodiment, a semantic understanding capability of the multi-modal foundation model for the multi-modal urban data may be enhanced through the self-supervised learning task based on the mask loss.

According to some embodiments, the loss of self-supervised learning task may include a cross-modal spatial alignment loss. The cross-modal spatial alignment loss may be calculated through the following steps S291 to S294.

In step S291, at least one of the plurality of point-of-interest data units is replaced with a set point-of-interest mask data unit, and at least one of the plurality of image data units is replaced with a set image mask data unit, to obtain masked first urban data.

For example, some tokens (for example, 15% of the tokens) in the point-of-interest data may be replaced with set mask tokens [M], and some image patches (for example, 40% of the image patches) in the image data may be replaced with blank image patches, to obtain the masked first urban data.

In step S292, the masked first urban data is input into the multi-modal foundation model to obtain a vector representation output by the multi-modal foundation model for each data unit in the masked first urban data.

In step S293, for each unmasked point-of-interest data unit, a second probability that a point of interest corresponding to the point-of-interest data unit is located in a masked image data unit is determined based on a vector representation of the point-of-interest data unit by using a second classifier. Specifically, the second probability output by the second classifier may be obtained by inputting the vector representation of the unmasked point-of-interest data unit into the second classifier. The second classifier may be, for example, a sigmoid classifier.

In step S294, a cross-modal spatial alignment loss of the multi-modal foundation model is determined based on the second probability corresponding to each unmasked point-of-interest data unit.

According to some embodiments, when the first urban data includes the point-of-interest data and the image data, the cross-modal spatial alignment loss [symbol] _{CMSA} may be calculated according to the following formula:

$${ℒ}_{CMSA} = {\sum }_{1 \leq i < {L}_{P} ∧ i ∉ {ℳ}_{P}} - {y}_{i} log p ( {y}_{i} \vert {h}_{i} ) - ( 1 - {y}_{i} ) log ( 1 - p ( {y}_{i} \vert {h}_{i} ) ) \qquad ( 9 )$$

where L_{P} represents a maximum position (maximum serial number) in the point-of-interest tokens, [symbol] represents a position of a masked point-of-interest token, and yᵢ is a binary classification label that represents whether an i^{th} unmasked point-of-interest token is located in a masked image patch. If the i^{th} unmasked point-of-interest token is located in the masked image patch, yᵢ=1. If the i^{th} unmasked point-of-interest token is not located in the masked image patch, yᵢ=0. p(yᵢ|hᵢ) indicates the second probability output by the second classifier.

According to some embodiments, in step S260, the overall loss of the multi-modal foundation model may be determined based on the respective knowledge distillation losses of the plurality of general-purpose foundation models and the cross-modal spatial alignment loss. The overall loss of the multi-modal foundation model may be, for example, a weighted sum of the respective knowledge distillation losses of the general-purpose foundation models and the cross-modal spatial alignment loss.

For example, when the plurality of general-purpose foundation models include the language foundation model, the visual foundation model, and the visual-language foundation model, the overall loss [symbol] of the multi-modal foundation model may be a sum of the knowledge distillation losses of the general-purpose foundation models and the cross-modal spatial alignment loss (weights of the four losses are all 1), that is,

$$ℒ = {ℒ}_{DLFM} + {ℒ}_{DVFM} + {ℒ}_{DVLFM} + {ℒ}_{CMSA} \qquad ( 10 )$$

where [symbol] _{DLFM}, [symbol] _{DVFM}, [symbol] _{DVLFM} are respectively the knowledge distillation losses of the language foundation model, the visual foundation model, and the visual-language foundation model, and [symbol] _{CMSA} is the cross-modal spatial alignment loss. For calculation manners of the four losses, refer to Formulas (3) to (5) and (9).

According to the above embodiment, the multi-modal foundation model can perceive a positional relationship between the points of interest and content of an image (satellite image) through a cross-modal spatial alignment loss-based self-supervised learning task, thereby implementing semantic alignment between the points of interest and the image.

According to some embodiments, in step S260, the overall loss of the multi-modal foundation model may be determined based on the respective knowledge distillation losses of the plurality of general-purpose foundation models, the mask loss, and the cross-modal spatial alignment loss. The overall loss of the multi-modal foundation model may be, for example, a weighted sum of the respective knowledge distillation losses of the general-purpose foundation models, the mask loss, and the cross-modal spatial alignment loss.

For example, when the plurality of general-purpose foundation models include the language foundation model, the visual foundation model, and the visual-language foundation model, the overall loss [symbol] of the multi-modal foundation model may be a sum of the knowledge distillation losses of the general-purpose foundation models, the mask loss, and the cross-modal spatial alignment loss (weights of the five losses are all 1), that is,

$$ℒ = {ℒ}_{DLFM} + {ℒ}_{DVFM} + {ℒ}_{DVLFM} + {ℒ}_{MGDM} + {ℒ}_{CMSA} \qquad ( 11 )$$

where [symbol] _{DLFM}, [symbol] _{DVFM}, [symbol] _{DVLFM} are respectively the knowledge distillation losses of the language foundation model, the visual foundation model, and the visual-language foundation model, [symbol] _{MGDM} is the mask loss, and [symbol] _{CMSA} is the cross-modal spatial alignment loss. For calculation manners of the five losses, refer to Formulas (3) to (5), (7), and (9).

In step S270, parameters of the multi-modal foundation model are adjusted to reduce the overall loss.

It can be understood that steps S210 to S270 may be repeatedly performed many times until a set termination condition is met. The multi-modal foundation model in this time is a trained first multi-modal foundation model. The set termination condition may be, for example, convergence of the overall loss, a set iteration quantity being reached, or the overall loss being less than a set threshold.

According to some embodiments, the trained first multi-modal foundation model is configured to generate a region vector representation of an urban region, where the region vector representation may be used as input of a prediction network, so that the prediction network identifies target information of the urban region based on the region vector representation.

The prediction network is a neural network configured to handle a downstream task of urban region identification. The prediction network may use any structure, for example, may include a multi-layer perceptron and a classification layer (for example, a softmax classification layer or a sigmoid classification layer).

According to some embodiments, the target information may include any of the following information: a type, a population, a traffic flow, and an economic index. Types of urban regions may include, for example, an urban village, a demolition region, a high population density region, a business region, a residential region, an industrial region, etc. The economic index may indicate, for example, economic situations such as housing prices and economic prosperity in the urban region.

The trained first multi-modal foundation model may be configured to handle any downstream task in the field of urban region identification. According to some embodiments, the prediction network for the downstream task may be trained by using second urban data of a second sample urban region based on the trained first multi-modal foundation model.

According to some embodiments, the prediction network for the downstream task may be trained through the following steps S201 to S205.

In step S201, second urban data of a second sample urban region, an information label of the second sample urban region, and the trained first multi-modal foundation model are obtained, where the second urban data includes a plurality of second data segments that respectively correspond to a plurality of data modalities.

In step S202, the second urban data is input into the first multi-modal foundation model to obtain respective segment vector representations output by the first multi-modal foundation model for the plurality of second data segments.

In step S203, a region vector representation of the second sample urban region is determined based on the respective segment vector representations of the plurality of second data segments.

In step S204, the region vector representation of the second sample urban region is input into the prediction network to obtain predicted information output by the prediction network for the second sample urban region.

In step S205, at least parameters of the prediction network are adjusted based on the predicted information and the information label.

According to the above embodiment, supervised training is performed on the prediction network by using the second urban data of the second sample urban region and the information label thereof, thereby improving a prediction capability of the prediction network for the downstream task, and improving accuracy of urban region identification.

According to some embodiments, the second sample urban region may be a same urban region as the first sample urban region described above. Similar to the first urban data of the first sample urban region, the second urban data of the second sample urban region may also include point-of-interest data and image data (for example, a satellite image). Further, the point-of-interest data may include names, categories, and geographic positions of points of interest in the second sample urban region.

According to some embodiments, in step S203, the respective segment vector representations of the plurality of second data segments may be fused to obtain the region vector representation of the second sample urban region.

For example, an average value of the respective segment vector representations of the plurality of second data segments may be determined as the region vector representation of the second sample urban region, or a sum, a weighted sum, or a concatenation result of the respective segment vector representations of the plurality of second data segments may be used as the region vector representation of the second sample urban region.

According to some embodiments, in step S204, the predicted information of the second sample urban region may be, for example, a type, a population, a traffic flow, and an economic index of the second sample urban region.

According to some embodiments, in step S205, a joint loss of the first multi-modal foundation model and the prediction network may be determined based on the predicted information and the information label. Further, parameters of the first multi-modal foundation model and the prediction network are adjusted simultaneously based on the joint loss. Therefore, supervised fine-tuning is implemented on the first multi-modal foundation model, so that a second multi-modal foundation model obtained after fine-tuning is more adapted to an urban region identification task corresponding to the prediction network, thereby improving identification accuracy of the urban region identification task. The joint loss may be calculated, for example, by using a cross-entropy loss function.

According to some embodiments, in step S205, a loss of the prediction network may be determined based on the predicted information and the information label. Further, the parameters of the prediction network are adjusted based on the loss. In this embodiment, the parameters of the first multi-modal foundation model are fixed and only the parameters of the prediction network are adjusted. Therefore, training efficiency of the prediction network can be improved.

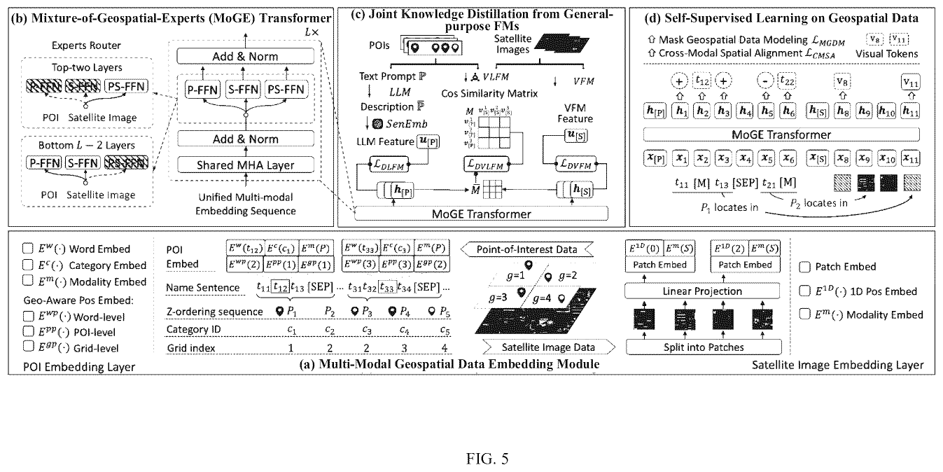

FIG. 5 is a schematic diagram of a multi-modal foundation model and a pre-training framework therefor according to embodiments of the present disclosure.

As shown in FIG. 5, the multi-modal foundation model (hereinafter referred to as the model or this model) used for the field of urban region identification in the embodiments of the present disclosure includes a multi-modal geospatial data embedding module and a mixture-of-geospatial-experts transformer (MoGE Transformer), shown as modules (a) and (b) in FIG. 5. The multi-modal geospatial data embedding module converts raw POI data and satellite image data into embedding sequences in the latent space, to comprehensively model and integrate text, visual, and geospatial information in the urban data. The mixture-of-geospatial-experts transformer is configured to perform deep interaction and fusion on multi-modal geographic data and generate a multi-modal region representation.

The pre-training framework for the multi-modal foundation model includes joint knowledge distillation from general-purposes foundation models and self-supervised learning on geospatial data, which are respectively shown as modules (c) and (d) in FIG. 5.

The following describes in detail the multi-modal geospatial data embedding module, the mixture-of-geospatial-experts transformer, the joint knowledge distillation strategy from general-purpose foundation models, and the self-supervised learning on geospatial data. For ease of description, [symbol] ={P₁, P₂, . . . , Pₘ} and S are respectively used to represent a POI set and a satellite image of an i^{th} urban region Rᵢ.

### 1. Multi-Modal Geospatial Data Embedding Module

The module encodes the raw POI data and satellite image data into compact vector embeddings, and considers geospatial context thereof in this process. Multi-modal geospatial data embeddings include an embedding of the POI data (POI Embedding) and an embedding of the satellite image data (Satellite Image Embedding).

### 1.1 POI Embedding

To model POIs in the urban region comprehensively, embodiments of the present disclosure provides a joint encoding manner, including: performing word embedding, geo-aware position embedding, and category embedding on the POIs. Obtaining the POI embedding in this joint encoding manner may effectively model textual toponym knowledge of the POIs and capture a spatial distribution of the POIs.

### 1.1.1 Word Embedding

An urban region is given, and a sequence is first constructed by using all POIs in the region, where the sequence includes names of the POIs. The POI name sequence may be considered as a pseudo sentence that matches input of a transformer model. Word embedding encoding is performed on the POI name sequence. Specifically, a sequence (or a pseudo sentence) including names of a POI set [symbol] ={P₁, P₂, . . . , Pₘ} in the region is: name₁ name₂ . . . nameₘ. The name sequence is tokenized and different POIs are separated by using a special token [SEP], to obtain the following tokenization result: t₁₁t₁₂ . . . t₁ₙ_{₁} [SEP]t₂₁t₂₂ . . . t₂ₙ_{₂}[SEP] . . . tₘ₁tₘ₂ . . . tₘₙ_{ₘ}, where tⱼₖ represents a kth token in a name of Pⱼ (that is, a j^{th} POI). Then, each token is mapped as a d-dimensional word embedding in the latent space by using a word embedding table E^{w}( ): E^{w}(tⱼₖ)∈ [symbol] ^{d}. The word embedding table E^{w}( ) is a trainable parameter of the multi-modal foundation model.

### 1.1.2 Geo-Aware Position Embedding

To consider a positional relationship between the tokens, embodiments of the present disclosure design geo-aware position encoding to replace conventional position encoding used in bidirectional encoder representations from transformers (BERT) and GPT. In the pseudo sentence, many tokens come from different POIs, and a distribution of the POIs in the urban region is irregular. Therefore, the tokens coming from different POIs do not follow rules found in human languages (such as grammar and sentence structures). Instead, the tokens have a specific spatial relationship based on a geographic distribution of the POIs, for example, some POIs are located close to each other while others are far apart. This characteristic makes conventional position encoding unavailable. Therefore, embodiments of the present disclosure design the geo-aware position encoding, to process complex sequence and spatial relationships between the tokens from three aspects:

### (1) Word-Level

For a specific POI Pⱼ in a region, an order of each token in a name of the POI is first represented by using a general position encoding, which is consistent with position encoding in BERT and GPT. Specifically, for a token tⱼₖ in the name nameⱼ of the POI, a word-level position embedding table E^{wp}( ) is used to map an order k of the token tⱼₖ in the name nameⱼ of the POI as a word-level position encoding E^{wp}(k). The word-level position embedding table E^{wp}( ) is a trainable parameter of the multi-modal foundation model.

### (2) POI-Level

A POI-level position encoding is used to model a spatial positional relationship between the tokens of different POIs. Inspired by the First Law of Geography (things that are close to each other are more related), it is hoped that the position encoding can reflect a relative distance between the POIs. Specifically, given an urban region, the urban region is first divided into grids with a fine granularity (with a size of 1 m*1 m), and the grids are serialized according to the Z-ordering strategy. In an obtained grid sequence, grids close to each other are arranged together. On this basis, POIs in the region are ordered based on grids in which the POIs are located, and an obtained POI sequence may reflect the relative distance between the POIs. In some cases, a plurality of POIs that are extremely close to each other may be located in a same grid and these POIs may be ordered randomly. It may be assumed that in [symbol] ={P₁, P₂, . . . , Pₘ}, a subscript j of Pⱼ represents a position of the POI in the sequence. A POI-level position embedding table E^{pp}( ) is used to map an order j of Pⱼ in the POI sequence as a POI-level position encoding E^{pp}(j). The POI-level position embedding table E^{pp}( ) is a trainable parameter of the multi-modal foundation model.

### (3) Grid-Level

The embodiment shown in FIG. 5 further considers a distribution of the POIs in two-dimensional space. Specifically, the urban region is first divided into G grids and the G grids are numbered as g=1, 2, . . . , G. Then, for a POI located in a grid g, a grid-level position embedding table E^{gp}( ) is used to map a serial number of the grid g as a grid-level position encoding E^{gp}(g). The grid-level position embedding table E^{gp}( ) is a trainable parameter of the multi-modal foundation model.

An overall geospatial position encoding E^{p}(tⱼₖ) of each token may be calculated in combination with the position encodings at the above three levels:

$${E}^{p} ( {t}_{jk} ) = {E}^{wp} ( k ) + {E}^{pp} ( j ) + {E}^{gp} ( g ) \qquad ( 12 )$$

### 1.1.3 Category Embedding

Considering that categories of the POIs reflect functional information thereof and play a crucial role in describing features of a region, the category ids of the POIs are also encoded. Specifically, a learnable embedding table E^{c}( ) may be used to map a category id cⱼ of the POI Pⱼ as a d-dimensional embedding in the latent space: E^{c}(cⱼ)∈ [symbol] ^{d}. Tokens of a same POI share a same category embedding.

Finally, the word embedding, the geo-aware position encoding, the category embedding, and an additional modality embedding E^{m}(P) are combined, to obtain a final POI embedding E^{p}(tⱼₖ) of the token tⱼₖ:

$${E}^{P} ( {t}_{jk} ) = {E}^{w} ( {t}_{jk} ) + {E}^{p} ( {t}_{jk} ) + {E}^{c} ( {c}_{j} ) + {E}^{m} ( P ) \qquad ( 13 )$$

A modality embedding table E^{m}( ) is used to map a point-of-interest data modality P or a satellite image data modality S as a d-dimensional modality embedding. The modality embedding table E^{m}( ) is a trainable parameter of the multi-modal foundation model.

In conclusion, POI data of a region is input into a POI embedding layer in the multi-modal geospatial data embedding module to generate a POI embedding sequence X^{P} corresponding to the POI data:

$${X}^{P} = \{ {x}_{[ P ]} , {x}_{1}^{P} , {x}_{2}^{P} , … , {x}_{{L}^{P} - 1}^{P} \} \qquad ( 14 )$$

Where xᵢ^{P} is an embedding of an i^{th} token in the POI name sequence obtained through calculation according to Formula (13), L^{P} represents a maximum sequence length allowed by the model, and x_{[P]} corresponds to a CLS token [P] at a head part of the sequence.

### 1.2 Satellite Image Embedding

Similar to a general visual foundation model, the satellite image may be split into patches, and the patches are encoded through linear transformation. Specifically, a satellite image S∈ [symbol] ^{H×W×3} is transformed into a patch sequence first, a size of a patch is s×s×3, and a length of the patch sequence is L^{S}=HW/(s*s). Then, each patch in the patch sequence is mapped as a d-dimensional vector representation through linear transformation. A learnable CLS token [S] may be inserted into a head part of the sequence, and learnable 1-D position encoding E^{1D}( ) and modality embedding E^{m}(S) are added to each patch.

In conclusion, a satellite image of a region is input into a satellite image embedding layer to generate a satellite image embedding sequence X^{S}:

$${X}^{S} = \{ {x}_{[ S ]} , {x}_{1}^{S} , {x}_{2}^{S} , … , {x}_{{L}^{S}}^{S} \} \qquad ( 15 )$$

Finally, the POI embedding sequence and the satellite image embedding sequence are concatenated to obtain a multi-modal embedding sequence X=[X^{P};X^{S}] of the region. A sequence length is L^{P}+L^{S}+1, and the sequence is used as input of the mixture-of-geospatial-experts transformer.

### 2. Mixture-of-Geospatial-Experts Transformer (MoGE Transformer)

A mixture-of-geospatial-experts (MoGE) transformer module is introduced after the embedding module. The module generates a contextualized region representation based on multi-modal input. The MoGE transformer uses a multiway transformer structure whose core idea is to apply a specialized sub-network to process different types of urban data. In such a strategy, different modality-specific patterns of the POIs and the satellite image may be considered, and cross-modal dependency may be captured.

As shown in module (b) in FIG. 5, for the MoGE transformer, a group of sub-networks are used to replace a single feed-forward network (FFN) in a standard transformer model, and the sub-networks use different parameters. These sub-networks are designated as geospatial experts for processing different types of data, including a sub-network (P-FFN) that processes the POI data, a sub-network (S-FFN) that processes the satellite image, and a sub-network (PS-FFN) that simultaneously processes two types of data.

This module structure has two advantages: First, geospatial data in different forms shows unique features, and it is difficult for a single network to effectively represent the geospatial data in different forms. In the MoGE transformer, different parts of an input sequence are routed to corresponding sub-networks according to modalities thereof, and these sub-networks may respectively process the different modality-specific patterns. Second, a shared multi-head attention (MHA) layer in the MoGE transformer uses a cross-modal shared multi-head self-attention (MSA) mechanism, to implement deep interaction and fusion of multi-modal data and capture of the cross-modal dependency. This is essential for multi-modal region representation learning.

As shown in module (b) in FIG. 5, the MoGE transformer includes L MoGE transformer processing units. Each processing unit includes a shared multi-head attention (MHA) layer, an Add&Norm layer, geospatial-experts sub-networks (P-FFN, S-FFN, and PS-FFN), and an Add&Norm layer that are connected in sequence. In the bottom (L-2) MoGE transformer processing units, the sub-network P-FFN and the sub-network S-FFN are respectively used to perform internal fusion on the POI embedding sequence and the satellite image embedding sequence. In the top two MoGE transformer processing units, the sub-network PS-FFN is used to simultaneously process the POI embedding sequence and the satellite image embedding sequence for deep interaction and fusion of the multi-modal data.

The MoGE transformer model uses the multi-modal embedding sequence X output by the multi-modal geospatial data embedding module as input, and outputs a processed vector representation sequence H={h₀,h₁,h₂, . . . , h_{L}}, where h_{[P]}=h₀ and h_{[S]}=h_{L}_{^{P}} correspond to two CLS tokens, and are respectively used to represent a pooled POI representation and a pooled satellite image representation.

For the above multi-modal foundation model, two types of target tasks are set to pre-train the model, that is, a knowledge distillation task and a self-supervised learning task. Three knowledge distillation objectives are introduced for the knowledge distillation task, to migrate general knowledge from the plurality of foundation models to this model, thereby improving the generalization capability thereof to handle the wide range of downstream tasks in the field of urban region identification. In addition, considering that knowledge in the geospatial field is essential for urban region identification, two self-supervised learning tasks are set to train the model to capture available features from the multi-modal urban data.

3. Joint Knowledge Distillation from General-Purpose FMs

To make the multi-modal foundation model universally effective in various urban region identification tasks, the model is enhanced with powerful representation capabilities of the general-purpose foundation models. Because the model needs to process multi-modal information including text data (the names of the POIs) and visual data (the satellite image), three knowledge distillation objectives are set to respectively migrate rich knowledge of the language foundation model (LFM), an image representation capability of the visual foundation model (VFM), and the semantic alignment capability of the visual-language foundation model (VLFM). Knowledge distillation follows a teacher-student paradigm, where this model is a student model and is guided by three teacher models: the LFM, the VFM, and the VLFM. A module (c) in FIG. 5 shows this teacher-student relationship.

3.1 Distillation from Language FM (DLFM)

A capability of the model to understand a regional function based on the POI data is enhanced through distillation from the large language model (LLM). A function and a possible resident activity of a region may be inferred by generating a region description based on the POI data by the LLM, and the region description is used as knowledge and encoded into an LLM feature. Then, a feature-based distillation method is used to guide the model to extract relevant semantic information from the POI data.

Specifically, given a POI set [symbol] of a region, a prompt text [symbol] is generated based on names of POIs. A format of the prompt text is: “There are the following facilities in the region: POI1, POI2, . . . . Please infer a function and a possible resident activity of the region”. The LLM uses the prompt to generate a function description [symbol] of the region. Then, the sentence embedding model is used to encode the generated function description [symbol] into a vector, which is referred to as the LLM feature. This process may be expressed as:

$${u}_{P} = SenEmb ( \overline{ℙ} ) \qquad ( 16 )$$

where u_{P} is the LLM feature, and SenEmb( ) represents an encoding process of the sentence embedding model.

Then, a cosine similarity between the LLM feature and a POI feature generated by the model is used to define an optimization objective of knowledge distillation:

$${ℒ}_{DLFM} = - Cos ( {σ}_{POI} ( {h}_{[ P ]} ) , {u}_{P} ) \qquad ( 17 )$$

where h_{[P]} is a vector representation generated by this model at the CLS token [P] and represents a POI representation, and σ_{POI}( ) is a linear transformation function and is used to map the POI representation to LLM feature space. The optimization objective enables the model to learn semantic information related to the regional function from the POI data under the teaching of the LLM feature. σ_{POI}( ) may be preset or may be a trainable parameter of the model.

Specific types of the LLM and the sentence embedding model are not limited in the embodiments of the present disclosure. For example, the LLM may be a ChatGLM-6B model, and the sentence embedding model may be a Moka massive mixed embedding (M3E)-base model.

3.2 Distillation from Visual FM (DVFM)

A representation capability of this model for the satellite image is enhanced through distillation from the visual foundation model (VFM). Given a satellite image S of a region, a pre-trained visual foundation model VFM ( ) is used as a teacher model to extract a semantic feature of the satellite image: u_{S}=VFM(S). Then, the teacher model uses, by using a cosine similarity-based distillation objective function, the feature to guide the model (student model) to learn a satellite image representation:

$${ℒ}_{DVFM} = - Cos ( {σ}_{Sate} ( {h}_{[ S ]} ) , {u}_{S} ) \qquad ( 18 )$$

where h_{[S]} is the satellite image representation generated by the model, and σ_{Sate}( ) represents a linear transformation function used for this distillation task. σ_{Sate}( ) may be preset or may be a trainable parameter of this model.
   3.3 Distillation from Visual-Language FM (DVLFM)

To further enhance the semantic alignment capability of the model for the multi-modal urban data, knowledge distillation is performed on the model by using the visual-language foundation model (VLFM). The visual-language foundation model is very powerful in terms of joint understanding, alignment, and the like of text-image content.

A core idea of this distillation task is as follows: The VLFM that is obtained through pre-training by using a large amount of data can encode a text and an image into the same latent space, so that in the latent space, a semantic similarity therebetween can be compared by calculating a cosine similarity between vector representations of data of different modalities. It is expected that the model can compare a semantic similarity between the data of different modalities like the VLFM, so that the cosine similarity between semantically similar POIs and satellite image is higher.

Therefore, for a batch of urban regions, the VLFM may be used to obtain vector representations of POIs and satellite images of these regions, and an inter-region POI-satellite image cross-modal cosine similarity matrix is calculated based on these vector representations. The similarity matrix reflects a relative relationship of semantic similarities between the POIs and the satellite images in different regions. Similarly, a cosine similarity matrix may also be calculated by using the model. To enable the model to learn a cross-modal semantic alignment capability of the VLFM, the cosine similarity matrix generated by the model may be matched to the matrix generated by the VLFM.

Specifically, given a batch of region samples {Rᵢ}ᵢ₌₁^{B} of a batch size B, the VLFM is used to encode POI and satellite image data thereof into semantic representations: {v_{P}ⁱ}ᵢ₌₁^{B} and {v_{S}ⁱ}ᵢ₌₁^{B}, and a cosine similarity matrix M∈ [symbol] ^{B×B} is calculated, where M_{i,j}=Cos(v_{P}ⁱ,v_{S}^{j}). In this matrix, an i^{th} row (column) reflects a semantic relationship between POIs (satellite image) of a region Rᵢ and satellite images (POIs) of other regions in this batch. In addition, the model also generates vector representations {h_{[P]}ⁱ}ᵢ₌₁^{B} and {h_{[S]}ⁱ}ᵢ₌₁^{B} of the two modalities and calculates a cosine similarity matrix M̅. The matrix has an element M̅ᵢⱼ=Cos(μ_{POI}(h_{[P]}ⁱ), μ_{Sate}(h_{[S]}^{j})), and μ_{POI}( ) and μ_{Sate}( ) are two linear transformation functions. The two functions may be preset or trainable parameters of the model. Then, an optimization objective for knowledge distillation from the VLFM is defined as minimizing KL divergence of corresponding rows and corresponding columns of the two matrices, that is, implementing matching of the matrix M and the matrix M:

$${ℒ}_{DVLFM} = {\sum }_{1 \leq i \leq B} KL ( ρ ( {\overline{M}}_{i} ) ‖ ρ ( {M}_{i} ) ) + {\sum }_{1 \leq j \leq B} KL ( ρ ( {\overline{M}}_{j}^{T} ) ‖ ρ ( {M}_{j}^{T} ) ) \qquad ( 19 )$$

where ρ represents a softmax function, and is used to transform rows and columns of the cosine similarity matrix into a probability distribution.

### 4. Self-Supervised Learning on Geospatial Data

To enable the model to learn domain knowledge from the urban data, two self-supervised tasks are used in this embodiment. The first task is mask geospatial data modeling (MGDM). This task enables the model to understand semantics of the POI and satellite image data. The second task is cross-modal spatial alignment (CMSA), which uses a spatial relationship between the POIs and the satellite image to promote alignment of the two modalities. The two self-supervised tasks are shown as a module (d) in FIG. 5.

### 4.1 Mask Geospatial Data Modeling (MGDM)

A mask-then-predict paradigm is widely applied to pre-training of the language, visual, and multi-modal foundation models. In the pre-training framework of the model, pre-training is also performed through mask modeling of the multi-modal urban data.

A general idea is that a part of POI and satellite image input data is masked, and the model is required to understand text content, visual content, and a spatial relationship of an unmasked part, and restore the masked part based on the information. For the input POI data, 15% of tokens are randomly masked and are replaced with special mask tokens [M]. Then, the model learns how to complete this part of information. For the satellite image, 40% of image patches are masked and discrete visual tokens are predicted for these positions.

[symbol] and [symbol] are respectively used to represent positions of the masked POI tokens and image patches, and a masked sequence is input into the model to obtain a vector representation sequence H. A training objective of this task is to minimize negative logarithmic likelihood of correct POI tokens and correct visual tokens in the positions [symbol] and [symbol] :

$${ℒ}_{MGDM} = - {\sum }_{i ∈ {ℳ}_{P}} log p ( {y}_{i}^{P} \vert {h}_{i} ) - {\sum }_{i ∈ {ℳ}_{S}} log p ( {y}_{i}^{S} \vert {h}_{i} ) \qquad ( 20 )$$

where p(yᵢ^{P}|hᵢ) of the first item represents a probability of correctly predicting a POI token yᵢ^{P} in a masked position. The prediction is performed by a two-layer multi-layer perceptron (MLP) classifier with a softmax function. p(yᵢ^{S}|hᵢ) of the second item represents a probability of correctly predicting a visual token yᵢ^{S} in a masked position.

### 4.2 Cross-Modal Spatial Alignment (CMSA)

Although the urban region is described by using the POIs and the satellite image from totally different perspectives, each POI corresponds to one place in the satellite image. This geospatial relationship may be used as a link to align semantics of the two modalities. A CMSA task is based on this idea, and enables the model to perceive the positional relationship between content of the POIs and the satellite image, thus facilitating semantic alignment between the two modalities.

Specifically, in the MGDM task, some image patches are masked; and in the CMSA task, the model is required to determine whether each POI is located in the masked region of the satellite image, that is, to perform binary classification on the vector representations of the POIs, thereby optimizing the model by using the binary cross-entropy loss function. It should be noted that the POI tokens masked in the MGDM task (these tokens are replaced with [M]) are not included in calculation of a loss function, to prevent the model from learning a mapping that simply predicts [M] as a positive class. This training objective may be expressed as:

$${ℒ}_{CMSA} = {\sum }_{1 \leq i < {L}_{P} ∧ ∉ {ℳ}_{P}} - {y}_{i} log p ( {y}_{i} \vert {h}_{i} ) - ( 1 - {y}_{i} ) log ( 1 - p ( {y}_{i} \vert {h}_{i} ) ) \qquad ( 21 )$$

A binary classification label y; represents whether a POI in this position is located in a masked patch, yᵢ=1 represents that the POI is located in the masked patch, and yᵢ=0 represents that the POI is not located in the masked patch. p(yᵢ|hᵢ) represents an output probability of a sigmoid classifier.

### 5. Pre-Training

The model is pre-trained by using the three knowledge distillation tasks and the two self-supervised tasks simultaneously, and an overall loss function is:

$$ℒ = {ℒ}_{MGDM} + {ℒ}_{CMSA} + {ℒ}_{DLFM} + {ℒ}_{DVFM} + {ℒ}_{DVLFM} \qquad ( 22 )$$

### 6. Downstream Prediction

After a pre-trained model is obtained, the POI vector representation h_{[P]} and the satellite image vector representation h_{[S]} that are output by the model may be averaged, to obtain a vector representation of the urban region. Then, the model may be applied to the downstream task in urban region identification in two manners.

### 6.1 Fine-tuning

A prediction network (for example, a linear regression network or a logistic regression classification network) for the downstream task is connected at an output end of the model, and the pre-trained model is trained together with the prediction network by using training data of the downstream task (that is, the parameters of the model and the prediction network are adjusted simultaneously).

### 6.2 Feature-Based Prediction

Different from the fine-tuning manner described above, in a feature-based prediction manner, weights of the pre-trained model are fixed, and only the prediction network is optimized in the downstream task (that is, only the parameters of the prediction network are adjusted).

In the multi-modal foundation model used for the field of urban region identification and the pre-training framework therefor that are provided in the embodiments of the present disclosure, the domain features in the multi-modal geographic data can be effectively fused with the general knowledge of the plurality of general-purpose foundation models, so that the multi-modal data can be better used, thereby effectively solving a wide range of urban region identification tasks. Specifically, first, compared with directly using the general-purpose foundation model, a specialized model structure is designed to jointly model text content, visual content, and spatial information of the multi-modal geographic data, and the geographic data is used for pre-training, so that the model has domain knowledge that is essential for a region identification task. Second, compared with training a specialized foundation model from the beginning based on the urban data, a large general-purpose model is distilled, and general knowledge of the large model enables the model to obtain a good generalization capability under a condition of limited training data. Third, a plurality of language, visual, and visual-language foundation models are distilled by using a method combining a single general-purpose foundation model with the urban data, to enhance the text understanding capability, the image representation capability, and the cross-modal alignment capability of the model, so that the model can better use the multi-modal geographic data, thereby solving a wider range of region identification tasks.

Based on the trained multi-modal foundation model (that is, the above first multi-modal foundation model), the embodiments of the present disclosure further provide an urban region identification method. FIG. 6 is a flowchart of an urban region identification method 600 according to embodiments of the present disclosure. An execution body of the method 600 may be a server (for example, the server 120 in FIG. 1) or a client device (for example, the client devices 101 to 106 in FIG. 1). As shown in FIG. 6, the method 600 includes steps S610 to S640.

In step S610, urban data of a target urban region to be identified is obtained. The urban data includes a plurality of data segments that respectively correspond to a plurality of data modalities.

In step S620, the urban data is input into a multi-modal foundation model to obtain respective segment vector representations output by the multi-modal foundation model for the plurality of data segments. The multi-modal foundation model is obtained by using the multi-modal foundation model training method 200 described above.

In step S630, a region vector representation of the target urban region is determined based on the respective segment vector representations of the plurality of data segments.

In step S640, target information of the target urban region is identified based on the region vector representation by using a prediction network.

According to embodiments of the present disclosure, the trained multi-modal foundation model is used to generate the region vector representation that can comprehensively and accurately express an urban region feature. This comprehensive and accurate region vector representation is applied to a downstream task of urban region identification, thereby improving accuracy and efficiency of urban region identification.

According to some embodiments, in step S610, the urban data of the target urban region includes, for example, point-of-interest data and image data. The point-of-interest data includes, for example, names, categories, and geographic positions of points of interest located in the target urban region. The image data includes, for example, a satellite image of the target urban region.

According to some embodiments, in step S630, the region vector representation of the target urban region is obtained by fusing the respective segment vector representations of the plurality of data segments.

For example, an average value of the respective segment vector representations of the plurality of data segments may be determined as the region vector representation of the target urban region, or a sum, a weighted sum, or a concatenation result of the respective segment vector representations of the plurality of data segments may be used as the region vector representation of the target urban region.

According to some embodiments, in step S640, the prediction network is a trained neural network for target information prediction in the context of an urban region identification task. The prediction network may be obtained through training, for example, through the steps S201 to S205 described above.

According to some embodiments, in step S640, the predicted information of the second sample urban region may be, for example, a type, a population, a traffic flow, and an economic index of the second sample urban region.

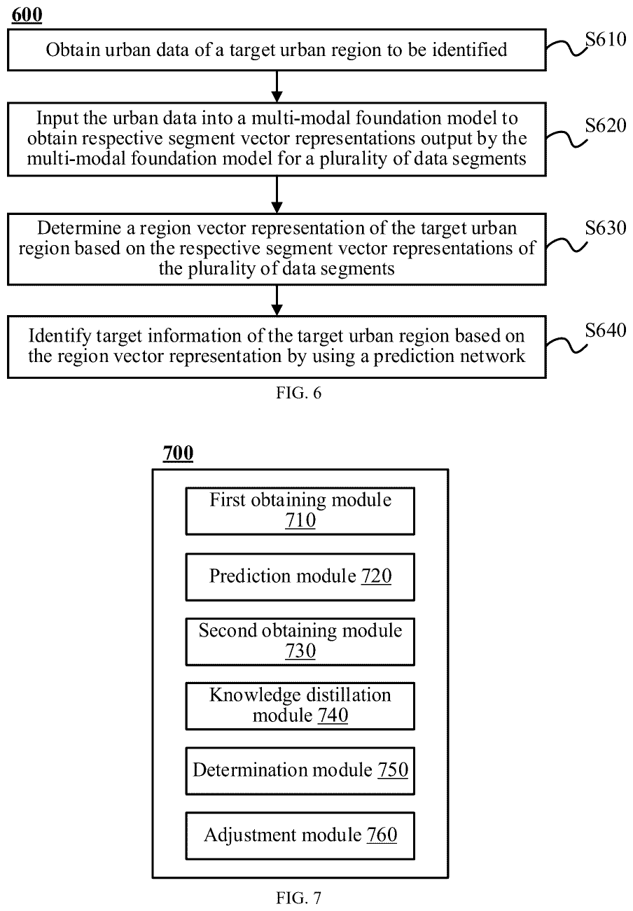

According to embodiments of the present disclosure, a multi-modal foundation model training apparatus is further provided. FIG. 7 is a block diagram of a structure of a multi-modal foundation model training apparatus 700 according to embodiments of the present disclosure. As shown in FIG. 7, the apparatus 700 includes a first obtaining module 710, a prediction module 720, a second obtaining module 730, a knowledge distillation module 740, a determination module 750, and an adjustment module 760.

The first obtaining module 710 is configured to obtain first urban data of a first sample urban region. The first urban data includes a plurality of first data segments that respectively correspond to a plurality of data modalities.

The prediction module 720 is configured to input the first urban data into a multi-modal foundation model to obtain respective predicted vector representations output by the multi-modal foundation model for the plurality of first data segment.

The second obtaining module 730 is configured to obtain a plurality of general-purpose foundation models that are pre-trained. Each of the plurality of general-purpose foundation models corresponds to at least one of the plurality of data modalities.

The knowledge distillation module 740 is configured to: for each of the plurality of general-purpose foundation models, perform the following operations: generate a vector representation label of a first data segment of a corresponding data modality by using the general-purpose foundation model; and determine a knowledge distillation loss of the general-purpose foundation model based on the vector representation label and a predicted vector representation of the first data segment.

The determination module 750 is configured to determine an overall loss of the multi-modal foundation model based on at least respective knowledge distillation losses of the plurality of general-purpose foundation models.

The adjustment module 760 is configured to adjust parameters of the multi-modal foundation model based on the overall loss.

According to embodiments of the present disclosure, a multi-modal foundation model that is used for the field of urban region identification and that can handle a wide range of downstream tasks is provided, and a pre-training method for the multi-modal foundation model is provided by using a self-supervised pre-training paradigm. Knowledge distillation is performed on existing general-purpose foundation models for different data modalities, so that the multi-modal foundation model in the embodiments of the present disclosure can fully learn multi-modal knowledge under the teaching of a plurality of existing general-purpose foundation models, thereby improving generalization performance thereof, enabling the multi-modal foundation model to accurately understand multi-modal urban data, and further generating general-purpose vector representations that can comprehensively and accurately express urban region features. The comprehensive and accurate vector representations may be widely applied to a plurality of downstream tasks of urban region identification, thereby improving accuracy and efficiency of urban region identification.

In the embodiments of the present disclosure, a general-purpose foundation model that has good generalization capability and understanding capability and that is used for the field of urban region identification can be obtained by using only limited unlabeled data without obtaining a large amount of labeled data and designing and training complex models for different urban region identification tasks, thereby improving efficiency and accuracy of urban region identification.

It should be understood that the various modules and units of the apparatus 700 shown in FIG. 7 may correspond to the steps in the method 200 described in FIG. 2. Therefore, the operations, features, and advantages described above for the method 200 are also applicable to the apparatus 700 and the modules and units included therein. For the sake of brevity, some operations, features, and advantages are not described herein again.

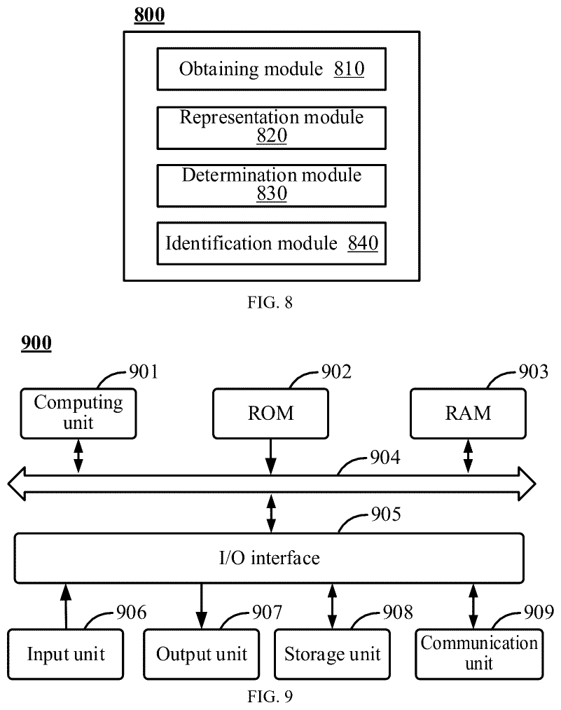

According to embodiments of the present disclosure, an urban region identification apparatus is further provided. FIG. 8 is a block diagram of a structure of an urban region identification apparatus 800 according to embodiments of the present disclosure. As shown in FIG. 8, the apparatus 800 includes an obtaining module 810, a representation module 820, a determination module 830, and an identification module 840.

The obtaining module 810 is configured to obtain urban data of a target urban region to be identified. The urban data includes a plurality of data segments that respectively correspond to a plurality of data modalities.

The representation module 820 is configured to input the urban data into a multi-modal foundation model to obtain respective segment vector representations output by the multi-modal foundation model for the plurality of data segments. The multi-modal foundation model is obtained through training by using the multi-modal foundation model training apparatus 700 described above.

The determination module 830 is configured to determine a region vector representation of the target urban region based on the respective segment vector representations of the plurality of data segments.

The identification module 840 is configured to identify target information of the target urban region based on the region vector representation by using a prediction network.

According to embodiments of the present disclosure, the trained multi-modal foundation model is used to generate the region vector representation that can comprehensively and accurately express an urban region feature. This comprehensive and accurate region vector representation is applied to a downstream task of urban region identification, thereby improving accuracy and efficiency of urban region identification.

It should be understood that the various modules and units of the apparatus 800 shown in FIG. 8 may correspond to the steps in the method 600 described in FIG. 6. Therefore, the operations, features, and advantages described above for the method 600 are also applicable to the apparatus 800 and the modules and units included therein. For the sake of brevity, some operations, features, and advantages are not described herein again.

Although specific functions are discussed above with reference to specific modules, it should be noted that the functions of the various modules discussed herein may be divided into a plurality of modules, and/or at least some functions of a plurality of modules may be combined into a single module.

It should be further understood that, various technologies may be described herein in the general context of software and hardware elements or program modules. The above units described with reference to FIG. 7 and FIG. 8 may be implemented in hardware or hardware combined with software and/or firmware. For example, these units may be implemented as computer program code/instructions configured to be executed in one or more processors and stored in a computer-readable storage medium. Alternatively, these units may be implemented as hardware logic/circuitry. For example, in some embodiments, one or more of the modules 710 to 760 and 810 to 840 may be implemented together in a system on chip (SoC). The SoC may include an integrated circuit chip (which includes a processor (e.g., a central processing unit (CPU), a microcontroller, a microprocessor, and a digital signal processor (DSP)), a memory, one or more communication interfaces, and/or one or more components in other circuits), and may optionally execute a received program code and/or include an embedded firmware to perform functions.

According to embodiments of the present disclosure, there is further provided an electronic device, including: at least one processor; and a memory communicatively connected to the at least one processor, where the memory stores instructions that can be executed by the at least one processor, and the instructions, when executed by the at least one processor, cause the at least one processor to perform the multi-modal foundation model training method and/or the urban region identification method according to the embodiments of the present disclosure.

According to embodiments of the present disclosure, a non-transitory computer-readable storage medium storing computer instructions is provided, where the computer instructions are used to cause a computer to perform the multi-modal foundation model training method and/or the urban region identification method according to the embodiments of the present disclosure.

According to embodiments of the present disclosure, a computer program product is further provided. The computer program product includes computer program instructions, where the computer program instructions, when executed by a processor, cause the multi-modal foundation model training method and/or the urban region identification method according to the embodiments of the present disclosure to be implemented.

Referring to FIG. 9, a block diagram of a structure of an electronic device 900 that can serve as a server or a client of the present disclosure is now described. The electronic device is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown in the present specification, their connections and relationships, and their functions are merely examples, and are not intended to limit the implementation of the present disclosure described and/or required herein.

As shown in FIG. 9, the electronic device 900 includes a computing unit 901. The computing unit may perform various appropriate actions and processing according to a computer program stored in a read-only memory (ROM) 902 or a computer program loaded from a storage unit 908 to a random access memory (RAM) 903. The RAM 903 may further store various programs and data required for the operation of the electronic device 900. The computing unit 901, the ROM 902, and the RAM 903 are connected to each other through a bus 904. An input/output

(I/O) interface 905 is also connected to the bus 904.

A plurality of components in the electronic device 900 are connected to the I/O interface 905, including: an input unit 906, an output unit 907, the storage unit 908, and a communication unit 909. The input unit 906 may be any type of device capable of entering information to the electronic device 900. The input unit 906 may receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 907 may be any type of device capable of presenting information, and may include, but is not limited to, a display, a speaker, a video/audio output terminal, a vibrator, and/or a printer. The storage unit 908 may include, but is not limited to, a magnetic disk and an optical disk. The communication unit 909 allows the electronic device 900 to exchange information/data with other devices through a computer network such as the Internet and/or various telecommunication networks, and may include, but is not limited to, a modem, a network interface card, an infrared communication device, a wireless communication transceiver, and/or a chipset, for example, a Bluetooth device, an 802.11 device, a Wi-Fi device, a WiMax device, or a cellular communication device.

The computing unit 901 may be various general-purpose and/or special-purpose processing components with processing and computing capabilities. Some examples of the computing unit 901 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 901 performs the various methods and processing described above, for example, the method 200 and the method 600. For example, in some embodiments, the method 200 and the method 600 may be implemented as a computer software program, which is tangibly contained in a machine-readable medium, such as the storage unit 908. In some embodiments, a part or all of the computer program may be loaded and/or installed onto the electronic device 900 via the ROM 902 and/or the communication unit 909. When the computer program is loaded to the RAM 903 and executed by the computing unit 901, one or more steps of the method 200 and the method 600 described above can be performed. Alternatively, in other embodiments, the computing unit 901 may be configured, by any other suitable means (for example, by means of firmware), to perform the method 200 and/or the 600.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: implementation in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. The program code may be provided for a processor or a controller of a general-purpose computer, a special-purpose computer, or other programmable data processing apparatuses, such that when the program code is executed by the processor or the controller, the functions/operations specified in the flowcharts and/or block diagrams are implemented. The program code may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other categories of apparatuses can also be used to provide interaction with the user; for example, feedback provided to the user can be any form of sensory feedback (for example, visual feedback, auditory feedback, or tactile feedback); and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communication network) in any form or medium. Examples of the communication network include: a local area network (LAN), a wide area network (WAN), the Internet, and a blockchain network.

A computer system may include a client and a server. The client and the server are generally far away from each other and usually interact through a communication network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

Although the embodiments or examples of the present disclosure have been described with reference to the drawings, it should be understood that the methods, systems and devices described above are merely example embodiments or examples, and the scope of the present disclosure is not limited by the embodiments or examples, and is only defined by the scope of the granted claims and the equivalents thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A method, comprising:
obtaining first urban data of a first sample urban region, wherein the first urban data comprises a plurality of first data segments that respectively correspond to a plurality of data modalities;
inputting the first urban data into a multi-modal foundation model to obtain respective predicted vector representations output by the multi-modal foundation model for the plurality of first data segments;
obtaining a plurality of general-purpose foundation models that are pre-trained, wherein each general-purpose foundation model of the plurality of general-purpose foundation models corresponds to at least one data modality of the plurality of data modalities;
for each general-purpose foundation model of the plurality of general-purpose foundation models:
generating a vector representation label of a first data segment of a corresponding data modality by using the general-purpose foundation model; and
determining a knowledge distillation loss of the general-purpose foundation model based on the vector representation label and a predicted vector representation of the first data segment;
determining an overall loss of the multi-modal foundation model based on at least respective knowledge distillation losses of the plurality of general-purpose foundation models; and
adjusting parameters of the multi-modal foundation model based on the overall loss.

2. The method according to claim 1, wherein the plurality of first data segments comprise point-of-interest data corresponding to a text modality, and the plurality of general-purpose foundation models comprise a language foundation model corresponding to the text modality, and wherein the generating the vector representation label of the first data segment comprises:
inputting at least part of the point-of-interest data into the language foundation model to obtain a description text generated by the language foundation model for the first sample urban region; and
encoding the description text to obtain a vector representation label of the point-of-interest data.

3. The method according to claim 1, wherein the plurality of first data segments comprise image data corresponding to an image modality, and the plurality of general-purpose foundation models comprise a visual foundation model corresponding to the image modality, and wherein the generating the vector representation label of the first data segment comprises:
inputting the image data into the visual foundation model to obtain a vector representation label output by the visual foundation model for the image data.

4. The method according to claim 1, wherein the plurality of general-purpose foundation models comprise a unimodal general-purpose foundation model, the unimodal general-purpose foundation model corresponding to one data modality of the plurality of data modalities, and wherein the determining the knowledge distillation loss of the general-purpose foundation model comprises:
performing linear transformation on the predicted vector representation of the first data segment to obtain a transformed predicted vector representation;
calculating a similarity between the transformed predicted vector representation and the vector representation label; and
determining a unimodal knowledge distillation loss of the unimodal general-purpose foundation model based on the similarity, wherein the unimodal knowledge distillation loss is negatively correlated with the similarity.

5. The method according to claim 1, wherein the plurality of general-purpose foundation models comprise a cross-modal general-purpose foundation model, the cross-modal general-purpose foundation model corresponding to a first data modality and a second data modality in the plurality of data modalities, and wherein the determining the knowledge distillation loss of the general-purpose foundation model comprises:
obtaining a first predicted vector representation and a first vector representation label of first data and a second predicted vector representation and a second vector representation label of second data of the first sample urban region, wherein the first data is a first data segment corresponding to the first data modality and the second data is a first data segment corresponding to the second data modality;
generating a predicted similarity matrix based on respective first predicted vector representations and second predicted vector representations of a plurality of first sample urban regions;
generating a similarity matrix label based on respective first vector representation labels and second vector representation labels of the plurality of first sample urban regions; and
determining a cross-modal knowledge distillation loss of the cross-modal general-purpose foundation model based on a dissimilarity between the predicted similarity matrix and the similarity matrix label, wherein the cross-modal knowledge distillation loss is positively correlated with the dissimilarity.

6. The method according to claim 5, wherein the first data modality is a text modality, the first data is point-of-interest data, the second data modality is an image modality, the second data is image data, and the cross-modal general-purpose foundation model is a visual-language foundation model.

7. The method according to claim 1, wherein each first data segment of the plurality of first data segments is split into a plurality of data units, and the method further comprises:
for each first data segment of the plurality of first data segments, separately replacing at least one data unit in the first data segment with a set mask data unit to obtain masked first urban data;
inputting the masked first urban data into the multi-modal foundation model to obtain a vector representation output by the multi-modal foundation model for each data unit in the masked first urban data;
for each masked data unit, determining, by using a first classifier, a first probability of correctly predicting an unmasked data unit corresponding to the masked data unit based on a vector representation of the masked data unit; and
determining a mask loss of the multi-modal foundation model based on the first probability corresponding to each masked data unit,
wherein the determining the overall loss of the multi-modal foundation model comprises:
determining the overall loss of the multi-modal foundation model based on the respective knowledge distillation losses of the plurality of general-purpose foundation models and the mask loss.

8. The method according to claim 1, wherein the first urban data comprises point-of-interest data of a text modality and image data of an image modality, the point-of-interest data being split into a plurality of point-of-interest data units and the image data being split into a plurality of image data units, and the method further comprises:
separately replacing at least one point-of-interest data unit of the plurality of point-of-interest data units with a set point-of-interest mask data unit, and separately replacing at least one image data unit of the plurality of image data units with a set image mask data unit, to obtain masked first urban data;
inputting the masked first urban data into the multi-modal foundation model to obtain a vector representation output by the multi-modal foundation model for each data unit in the masked first urban data;
for each unmasked point-of-interest data unit, determining, by using a second classifier based on a vector representation of the point-of-interest data unit, a second probability that a point of interest corresponding to the point-of-interest data unit is located in a masked image data unit; and
determining a cross-modal spatial alignment loss of the multi-modal foundation model based on the second probability corresponding to each unmasked point-of-interest data unit.

9. The method according to claim 1, wherein the first urban data comprises point-of-interest data of a text modality and image data of an image modality, and the multi-modal foundation model comprises a point-of-interest encoder, an image encoder, and a multi-modal transformer, and wherein the inputting the first urban data into the multi-modal foundation model to obtain respective predicted vector representations for the plurality of first data segments comprises:
inputting the point-of-interest data into the point-of-interest encoder to obtain a point-of-interest embedding sequence of the point-of-interest data, wherein the point-of-interest embedding sequence comprises an embedding of each point-of-interest data unit in the point-of-interest data;
inputting the image data into the image encoder to obtain an image embedding sequence of the image data, wherein the image embedding sequence comprises an embedding of each image data unit in the image data; and
inputting the point-of-interest embedding sequence and the image embedding sequence into the multi-modal transformer, so that the multi-modal transformer fuses and updates the point-of-interest embedding sequence and the image embedding sequence, to obtain a predicted vector representation of the point-of-interest data and a predicted vector representation of the image data.

10. The method according to claim 9, wherein the point-of-interest data comprises respective names, geographic positions, and categories of a plurality of points of interest located in the first sample urban region, and wherein the inputting the point-of-interest data into the point-of-interest encoder to obtain the point-of-interest embedding sequence of the point-of-interest data comprises:
inputting the point-of-interest data into the point-of-interest encoder, so that the point-of-interest encoder performs the following operations:
representing the respective names of the plurality of points of interest as a point-of-interest name sequence, wherein each token in the point-of-interest name sequence is one point-of-interest data unit; and
for each token in the point-of-interest name sequence, generating an embedding of the token based on at least one of: the token, a geographic position or a category of a point of interest corresponding to the token.

11. The method according to claim 10, wherein the representing the respective names of the plurality of points of interest as the point-of-interest name sequence comprises:
ordering the plurality of points of interest based on a relative distance between the plurality of points of interest to obtain a point-of-interest sequence;
combining the names of the points of interest in the point-of-interest sequence to obtain a point-of-interest name pseudo sentence; and
tokenizing the point-of-interest name pseudo sentence to obtain the point-of-interest name sequence.

12. The method according to claim 11, wherein the ordering the plurality of points of interest to obtain the point-of-interest sequence comprises:
dividing the first sample urban region into a plurality of first grids of a same size, wherein the plurality of first grids form a plurality of grid pairs, each grid pair of the plurality of grid pairs comprises two adjacent first grids;
ordering the plurality of first grids according to a set ordering strategy to obtain a grid sequence, wherein two first grids in part of the plurality of grid pairs are adjacent in the grid sequence; and
separately obtaining a point of interest located in each first grid in the grid sequence to obtain the point-of-interest sequence.

13. The method according to claim 10, wherein the generating the embedding of the token comprises:
encoding the token to obtain a word embedding of the token;
generating a geographic position embedding of the token based on the geographic position of the point of interest corresponding to the token;
encoding the category of the point of interest corresponding to the token to obtain a category embedding of the token; and
determining the embedding of the token based on the word embedding, the geographic position embedding, and the category embedding.

14. The method according to claim 13, wherein the generating the geographic position embedding of the token comprises:
obtaining a plurality of pieces of position information of different granularities for the token based on the geographic position of the point of interest corresponding to the token; and
generating the geographic position embedding of the token based on the plurality of pieces of position information.

15. The method according to claim 14, wherein the plurality of pieces of position information comprise a first position of the token in a name of the point of interest, a second position of the point of interest in a point-of-interest sequence corresponding to the point-of-interest name sequence, and a second grid in which the point of interest is located, the second grid being obtained by performing average division on the first sample urban region, and wherein the generating the geographic position embedding of the token comprises:
encoding the first position to obtain a word position embedding of the token;
encoding the second position to obtain a point-of-interest position embedding of the token;
encoding an identifier of the second grid to obtain a grid position embedding of the token; and
fusing the word position embedding, the point-of-interest position embedding, and the grid position embedding to obtain the geographic position embedding of the token.

16. The method according to claim 1, further comprising:
obtaining second urban data of a second sample urban region, an information label of the second sample urban region, and a trained first multi-modal foundation model, wherein the second urban data comprises a plurality of second data segments that respectively correspond to a plurality of data modalities;
inputting the second urban data into the first multi-modal foundation model to obtain respective segment vector representations output by the first multi-modal foundation model for the plurality of second data segments;
determining a region vector representation of the second sample urban region based on the respective segment vector representations of the plurality of second data segments;
inputting the region vector representation of the second sample urban region into a prediction network to obtain predicted information output by the prediction network for the second sample urban region; and
adjusting at least parameters of the prediction network based on the predicted information and the information label.

17. The method according to claim 1, further comprising:
obtaining urban data of a target urban region to be identified, wherein the urban data comprises a plurality of data segments that respectively correspond to the plurality of data modalities;
inputting the urban data into a trained first multi-modal foundation model to obtain respective segment vector representations output by the multi-modal foundation model for the plurality of data segments;
determining a region vector representation of the target urban region based on the respective segment vector representations of the plurality of data segments; and
identifying target information of the target urban region based on the region vector representation by using a prediction network.

18. The method according to claim 17, wherein the target information comprises any of the following information: a type, a population, a traffic flow, or an economic index.

19. An electronic device, comprising:
a processor; and
a memory communicatively connected to the processor;
wherein the memory stores instructions executable by the processor, and the instructions, when executed by the processor, cause the processor to perform operations comprising:
obtaining first urban data of a first sample urban region, wherein the first urban data comprises a plurality of first data segments that respectively correspond to a plurality of data modalities;
inputting the first urban data into a multi-modal foundation model to obtain respective predicted vector representations output by the multi-modal foundation model for the plurality of first data segments;
obtaining a plurality of general-purpose foundation models that are pre-trained, wherein each general-purpose foundation model of the plurality of general-purpose foundation models corresponds to at least one data modality of the plurality of data modalities;
for each general-purpose foundation model of the plurality of general-purpose foundation models:
generating a vector representation label of a first data segment of a corresponding data modality by using the general-purpose foundation model; and
determining a knowledge distillation loss of the general-purpose foundation model based on the vector representation label and a predicted vector representation of the first data segment;
determining an overall loss of the multi-modal foundation model based on at least respective knowledge distillation losses of the plurality of general-purpose foundation models; and
adjusting parameters of the multi-modal foundation model based on the overall loss.

20. A non-transitory computer readable storage medium storing computer instructions, wherein the computer instructions are configured to enable a computer to perform operations comprising:
obtaining first urban data of a first sample urban region, wherein the first urban data comprises a plurality of first data segments that respectively correspond to a plurality of data modalities;
inputting the first urban data into a multi-modal foundation model to obtain respective predicted vector representations output by the multi-modal foundation model for the plurality of first data segments;
obtaining a plurality of general-purpose foundation models that are pre-trained, wherein each general-purpose foundation model of the plurality of general-purpose foundation models corresponds to at least one data modality of the plurality of data modalities;
for each general-purpose foundation model of the plurality of general-purpose foundation models:
generating a vector representation label of a first data segment of a corresponding data modality by using the general-purpose foundation model; and
determining a knowledge distillation loss of the general-purpose foundation model based on the vector representation label and a predicted vector representation of the first data segment;
determining an overall loss of the multi-modal foundation model based on at least respective knowledge distillation losses of the plurality of general-purpose foundation models; and
adjusting parameters of the multi-modal foundation model based on the overall loss.
